(19) United States
(12) Patent Application Publication
(10) Pub. No.: US 2026/0320442 A1
(43) Pub. Date: Oct. 15, 2026

(54) Hallucination Suppression in a Mobile Persistent Cognitive Machine via Admissibility-Governed Thought Cache Dynamics

(71) Applicant: AtomBeam Technologies Inc., Moraga, CA (US)

(72) Inventors: Brian Galvin, Silverdale, WA (US); Alexandria Tucker, Urbana, IL (US)

(21) Appl. No.: 19/659,151

(22) Filed: Apr. 27, 2026

Related U.S. Application Data
(63) Continuation-in-part of application No. 19/649,400, filed on Apr. 16, 2026.
Application No. 19/649,400 is a continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/444,172, filed on Jan. 8, 2026.
Application No. 19/444,172 is a continuation-in-part of application No. 19/294,125, filed on Aug. 7, 2025, now Pat. No. 12,579,437.
Application No. 19/294,125 is a continuation-in-part of application No. 19/178,873, filed on Apr. 15, 2025, now Pat. No. 12,608,631.
Application No. 19/178,873 is a continuation-in-part of application No. 19/177,611, filed on Apr. 13, 2025, now Pat. No. 12,572,471.
Application No. 19/177,611 is a continuation-in-part of application No. 19/051,193, filed on Feb. 12, 2025, now Pat. No. 12,387,050.
(60) Provisional application No. 63/868,329, filed on Aug. 21, 2025.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.
(60) Provisional application No. 64/011,093, filed on Mar. 19, 2026.
(60) Provisional application No. 64/011,100, filed on Mar. 19, 2026.
(60) Provisional application No. 64/011,104, filed on Mar. 19, 2026.
(60) Provisional application No. 64/011,106, filed on Mar. 19, 2026.
(60) Provisional application No. 64/011,111, filed on Mar. 19, 2026.
(60) Provisional application No. 64/012,356, filed on Mar. 20, 2026.
(60) Provisional application No. 64/012,364, filed on Mar. 20, 2026.
(60) Provisional application No. 64/012,371, filed on Mar. 20, 2026.
(60) Provisional application No. 64/012,381, filed on Mar. 20, 2026.
(60) Provisional application No. 64/012,389, filed on Mar. 20, 2026.

(51) Int. Cl. G06N 5/04; G06F 16/906

(52) U.S. Cl. CPC G06N 5/04; G06F 16/906

(57) ABSTRACT

A mobile and distributed persistent cognitive system governs cached thought retrieval, synthesis, and expression through an epistemic control architecture enforcing structural admissibility, coherence monitoring, and irreversible suppression across a multi-tier thought cache comprising local device, user-specific cloud, and global generalized storage tiers. Each candidate thought retrieved from the cache is evaluated for epistemic admissibility prior to participation in response generation, with denied thoughts projected into irreversible reservoirs through non-invertible operations that persistently exclude structurally similar reasoning from future retrieval and synthesis. Admitted thoughts are monitored for coherence during reasoning traversal and routed to graduated output modes comprising direct, qualified, partial, withheld, and deferred response expressions conditioned on epistemic provenance. When operating without network connectivity, the system adapts cached thoughts subject to the same epistemic governance regime and queues constraint artifacts for synchronization upon connectivity restoration. Execution profiles are jointly governed by resource state and epistemic risk.

### CROSS-REFERENCE TO RELATED APPLICATIONS

Priority is claimed in the application data sheet to the following patents or patent applications, each of which is expressly incorporated herein by reference in its entirety:
Ser. No. 19/649,400
Ser. No. 19/550,709
Ser. No. 19/548,024
Ser. No. 19/546,407
Ser. No. 19/534,677
64/012,356
64/012,364
64/012,371
64/012,381
64/012,389
64/011,093
64/011,100
64/011,104
64/011,106
64/011,111
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
63/965,242
63/941,637
63/941,642
63/901,793
Ser. No. 19/444,172
63/868,329
Ser. No. 19/294,125
Ser. No. 19/178,873
Ser. No. 19/177,611
Ser. No. 19/051,193

### BACKGROUND OF THE INVENTION

### Field of the Art

The present invention relates to the field of artificial intelligence and cognitive computing systems, and more particularly to mobile and distributed persistent cognitive machine architectures in which intermediate reasoning outputs are generated, cached, and reused across a multi-tier storage hierarchy subject to epistemic admissibility evaluation, coherence monitoring, and irreversible suppression control.

### Discussion of the State of the Art

Contemporary artificial intelligence systems deployed on mobile and edge computing devices face a fundamental tension between reasoning quality and computational efficiency. Prevailing approaches address this tension by reducing model size, applying quantization techniques, or restricting the scope of inference operations to fit within available memory and power budgets. While such approaches reduce computational overhead, they do so by degrading reasoning capability rather than by making more efficient use of reasoning that has already been performed. The result is a class of mobile and edge AI systems that sacrifice response quality under resource constraints rather than preserving it through intelligent reuse of prior reasoning.

Thought caching and intermediate reasoning reuse architectures have emerged as an alternative approach in which reasoning outputs generated during prior interactions are stored and retrieved for application to subsequent prompts, reducing the need to regenerate reasoning from scratch for each interaction. Such architectures offer meaningful efficiency gains on resource-constrained devices and support continued operation during periods of network unavailability by drawing on locally cached reasoning content. However, existing thought caching systems treat cached reasoning outputs as available for reuse on the basis of semantic similarity or relevance alone, without evaluating whether a retrieved or synthesized reasoning output is epistemically appropriate for the context in which it is to be reused. A cached thought that was generated under conditions that no longer hold, that conflicts with subsequently acquired knowledge, or that was derived through a reasoning path that would not be sanctioned under current epistemic constraints may nonetheless be retrieved and applied without restriction, introducing reliability risks that are not addressed by the caching and retrieval mechanisms themselves.

Furthermore, existing thought caching architectures do not maintain structural records of reasoning patterns that have been identified as inadmissible or unreliable, and therefore cannot prevent future retrieval and reuse of structurally similar inadmissible reasoning. Synthesis and transformation operations applied to cached thoughts during offline adaptation are likewise unconstrained, permitting the combination or modification of cached thoughts in ways that may introduce contradiction, drift, or epistemic incoherence without detection or suppression. Output generation in existing systems is not conditioned on the epistemic provenance of the reasoning from which a response is derived, such that responses generated from adapted, transformed, or partially corroborated reasoning are expressed with the same confidence as responses derived from directly applicable and fully validated cached content.

What is needed is a mobile and distributed persistent cognitive system in which cached thought retrieval, synthesis, transformation, and offline adaptation are governed by an epistemic control architecture that evaluates candidate thoughts for structural admissibility prior to reuse, monitors reasoning trajectories involving cached thoughts for coherence during traversal, irreversibly suppresses structurally inadmissible reasoning patterns to prevent their recurrence in future retrieval and synthesis operations, and conditions output generation and expression on the epistemic provenance of the reasoning from which each response is derived, thereby providing structurally governed reliability across the full lifecycle of thought caching, reuse, and expression on resource-constrained and intermittently-connected computing devices.

### SUMMARY OF THE INVENTION

Accordingly, the inventor has conceived and reduced to practice, a mobile and distributed persistent cognitive system governs cached thought retrieval, synthesis, and expression through an epistemic control architecture enforcing structural admissibility, coherence monitoring, and irreversible suppression across a multi-tier thought cache comprising local device, user-specific cloud, and global generalized storage tiers. Each candidate thought retrieved from the cache is evaluated for epistemic admissibility prior to participation in response generation, with denied thoughts projected into irreversible reservoirs through non-invertible operations that persistently exclude structurally similar reasoning from future retrieval and synthesis. Admitted thoughts are monitored for coherence during reasoning traversal and routed to graduated output modes comprising direct, qualified, partial, withheld, and deferred response expressions conditioned on epistemic provenance. When operating without network connectivity, the system adapts cached thoughts subject to the same epistemic governance regime and queues constraint artifacts for synchronization upon connectivity restoration. Execution profiles are jointly governed by resource state and epistemic risk.

According to a preferred embodiment, a computer system comprising a hardware memory, wherein the computer system is configured to execute software instructions stored on nontransitory machine-readable storage media that: receive a prompt; retrieve one or more candidate thoughts from a thought cache, wherein each candidate thought is a previously generated intermediate reasoning output associated with a prior prompt; evaluate epistemic admissibility of each retrieved candidate thought prior to incorporating the candidate thought into response generation, wherein evaluating epistemic admissibility comprises determining, based on one or more structural properties of an epistemically conditioned cognitive substrate maintained by the system, at least one of: structural compatibility of the candidate thought with a current prompt context, a capacity condition of a region of the cognitive substrate associated with the candidate thought, conflict between the candidate thought and constraint representations stored in one or more irreversible reservoirs, or an admissibility boundary condition applicable to the candidate thought; admit candidate thoughts satisfying epistemic admissibility for participation in response generation and deny admission to candidate thoughts that do not satisfy epistemic admissibility; generate a response to the prompt using one or more admitted candidate thoughts; during generation of the response, monitor epistemic coherence of reasoning involving the admitted candidate thoughts by tracking a path-dependent coherence quantity and detecting a coherence failure condition; in response to detecting a coherence failure condition, intervene in the reasoning by at least one of interrupting, redirecting, or marking as inadmissible the reasoning in which the coherence failure was detected; in response to determining that a candidate thought or reasoning involving a candidate thought is epistemically inadmissible, generate a constraint representation and project the constraint representation into one or more irreversible reservoirs through a non-invertible operation, wherein the projected constraint representation influences subsequent thought retrieval and admissibility evaluations; and generate an output conditioned on epistemic admissibility status of the reasoning from which the output is derived; wherein when the computing device operates without network connectivity, the system adapts cached thoughts to address the prompt subject to epistemic admissibility evaluation, coherence monitoring, and output conditioning, is disclosed.

According to an aspect of an embodiment, the computer system is further configured to execute software instructions stored on the nontransitory machine-readable storage media that process the prompt using a first large language model optimized for execution on a resource-constrained computing device to generate a plurality of thoughts, and wherein generating the response comprises routing the prompt and one or more admitted candidate thoughts through a second large language model having fewer parameters than the first large language model.

According to an aspect of an embodiment, the thought cache comprises a local device cache stored on the computing device, a user-specific cloud cache storing a complete thought history for a user encrypted with user-specific keys, and a global generalized thought cache storing abstracted reasoning patterns applicable across a plurality of users, and wherein candidate thoughts are retrieved from one or more of the local device cache, the user-specific cloud cache, or the global generalized thought cache based on relevance to the prompt.

According to an aspect of an embodiment, evaluating epistemic admissibility of a candidate thought further comprises evaluating a structural compatibility residual measuring deviation between a geometric structure associated with the candidate thought and a geometric structure of a region of the epistemically conditioned cognitive substrate corresponding to the current prompt context, and denying admission when the structural compatibility residual exceeds a compatibility threshold, thereby preventing incorporation of candidate thoughts whose evidential grounding is geometrically incompatible with the current reasoning context.

According to an aspect of an embodiment, evaluating epistemic admissibility of a candidate thought further comprises querying the one or more irreversible reservoirs to determine whether the candidate thought matches a constraint representation stored therein, wherein a match indicates structural similarity to a previously identified inadmissible reasoning pattern, and denying admission to candidate thoughts for which a match is detected, such that constraint representations derived from prior inadmissible reasoning persistently exclude structurally similar candidate thoughts from future response generation without reconstructing the original inadmissible reasoning.

According to an aspect of an embodiment, monitoring epistemic coherence comprises classifying reasoning involving admitted candidate thoughts into phase regimes based on a magnitude of the path-dependent coherence quantity, comprising a coherent regime in which the path-dependent coherence quantity remains below a first threshold and consolidation of conclusions is permitted, a drift regime in which the path-dependent coherence quantity exceeds the first threshold but remains below a second threshold and consolidation is deferred pending corroboration by an independent reasoning path that reaches a substantially similar conclusion while remaining within the coherent regime, and an inversion regime in which the path-dependent coherence quantity meets or exceeds the second threshold and consolidation is blocked.

According to an aspect of an embodiment, the computer system is further configured to execute software instructions stored on the nontransitory machine-readable storage media that, when no directly admissible candidate thought is available for the prompt, synthesize a candidate thought by combining or transforming one or more cached thoughts, and wherein synthesized candidate thoughts are subject to epistemic admissibility evaluation and coherence monitoring under the same phase regime classification applied to retrieved candidate thoughts, and wherein a synthesized candidate thought that induces a drift or inversion regime classification is suppressed or generates a qualified output rather than a direct response.

According to an aspect of an embodiment, projecting the constraint representation into the one or more irreversible reservoirs through a non-invertible operation comprises discarding reconstructable details of the inadmissible candidate thought or reasoning trajectory while preserving a canonical constraint identifier usable to detect structurally similar inadmissible patterns in subsequent thought retrieval and admissibility evaluations, such that the original inadmissible thought or trajectory cannot be recovered from the projected constraint representation.

According to an aspect of an embodiment, the one or more irreversible reservoirs apply asymmetric constraint feedback to subsequent admissibility evaluations by providing read-only constraint pattern indices that influence admission decisions without being modifiable by active reasoning or response generation, such that the constraint feedback persistently narrows the set of admissible reasoning trajectories available for future thought reuse without permitting active reasoning to alter or erase stored constraint representations.

According to an aspect of an embodiment, generating an output conditioned on epistemic admissibility status comprises selecting among a plurality of output modes comprising a direct response mode in which a response is generated from one or more candidate thoughts that satisfied epistemic admissibility without transformation, a qualified response mode in which a response generated from transformed or synthesized candidate thoughts is accompanied by an indication that the response is derived from adapted reasoning rather than directly admissible cached content, a partial response mode in which only portions of a candidate response supported by admissible reasoning are expressed and unsupported portions are withheld, and a deferred response mode in which response generation is withheld pending restoration of network connectivity to enable retrieval of higher-admissibility candidate thoughts from remote cache tiers.

According to an aspect of an embodiment, when the computing device operates without network connectivity and no directly admissible candidate thought is available, the system selects an offline adaptation strategy comprising at least one of broadening a cached thought to extract underlying principles applicable to the current prompt, combining elements from a plurality of partially relevant cached thoughts to construct a composite candidate thought, applying a reasoning pattern from a cached thought in one domain to a structurally analogous situation in the domain of the current prompt, or modifying a cached thought through controlled parameter adjustments to align it with current prompt requirements, wherein each adapted candidate thought produced by the selected strategy is evaluated for epistemic admissibility prior to use in response generation and wherein the output mode is selected based on the admissibility status of the adapted candidate thought.

According to an aspect of an embodiment, each thought stored in the thought cache is assigned an epistemic status selected from a plurality of epistemic status tiers comprising at least a provisional status indicating that the thought has not yet been evaluated for admissibility, an admissible status indicating that the thought has satisfied epistemic admissibility evaluation and is eligible for reuse in response generation, a quarantined status indicating that the thought has exhibited coherence failure conditions during prior reuse and is excluded from response generation pending further evaluation, and a suppressed status indicating that the thought has been determined to be epistemically inadmissible and a corresponding constraint representation has been projected into the one or more irreversible reservoirs, wherein the epistemic status of each thought is maintained as metadata associated with the thought in the thought cache and is updated as the thought undergoes admissibility evaluation, reuse, and coherence monitoring.

According to an aspect of an embodiment, the computer system is further configured to execute software instructions stored on the nontransitory machine-readable storage media that promote a thought from a lower epistemic status tier to a higher epistemic status tier when the thought accumulates a history of successful admissibility evaluations and coherence-regime-consistent reuse across a plurality of prompts, and demote a thought to a lower epistemic status tier or to suppressed status when the thought exhibits coherence failure conditions, generates contradiction measures exceeding a threshold, or matches a constraint representation stored in the one or more irreversible reservoirs, such that epistemic status tiers are dynamically maintained based on accumulated reuse history rather than being fixed at thought generation time.

According to an aspect of an embodiment, the computer system is further configured to execute software instructions stored on the nontransitory machine-readable storage media that, prior to publishing a thought from the user-specific cloud cache to the global generalized thought cache, apply a dual-gate publication criterion requiring that the thought satisfies both a privacy criterion comprising removal of user-identifying information and context, and an epistemic criterion comprising at least one of a minimum epistemic status tier, an absence of matching constraint representations in the one or more irreversible reservoirs, a history of admissibility-consistent reuse across a plurality of contexts, and a contradiction measure below a publication threshold, such that thoughts are not promoted to the global generalized thought cache on the basis of privacy sanitization alone.

According to an aspect of an embodiment, the epistemic criterion further requires that the thought demonstrates stability under reuse, comprising maintaining coherent phase regime classification across a plurality of independent reasoning trajectories that employ the thought in different prompt contexts, and wherein a thought that satisfies the privacy criterion but fails the stability requirement is assigned quarantined status and is not published to the global generalized thought cache until stability is demonstrated, such that the global generalized thought cache contains only thoughts whose admissibility has been corroborated across diverse reuse contexts.

According to an aspect of an embodiment, the computer system is further configured to execute software instructions stored on the nontransitory machine-readable storage media that adjust an execution profile for response generation based on a combination of a resource state of the computing device comprising at least one of a battery level, available memory, or network connectivity state, and an epistemic risk level associated with available candidate thoughts comprising at least one of an epistemic status tier of the candidate thoughts, a magnitude of the path-dependent coherence quantity observed during prior reuse of the candidate thoughts, or a proximity of the candidate thoughts to constraint representations stored in the one or more irreversible reservoirs, wherein under conditions of low resource state or elevated epistemic risk, the system preferentially selects candidate thoughts of higher epistemic status, narrows the scope of response generation, or transitions to a qualified or deferred output mode.

According to an aspect of an embodiment, adjusting the execution profile comprises, when battery level of the computing device falls below a power threshold, dynamically reducing a complexity of thought generation and preferentially reusing cached thoughts of admissible epistemic status over generating new thoughts, and scheduling intensive thought generation, admissibility evaluation, and synchronization operations for periods in which the computing device is connected to a charging source, such that epistemic governance operations are distributed across available power states to maintain response quality while conserving battery resources.

According to an aspect of an embodiment, synchronization between the local device cache and the user-specific cloud cache comprises transferring not only thought content but also associated epistemic metadata comprising at least one of the epistemic status tier assigned to each thought, a history of admissibility evaluation outcomes for each thought, coherence regime classifications observed during prior reuse of each thought, and identifiers of constraint representations in the one or more irreversible reservoirs that are relevant to each thought, such that admissibility governance state accumulated on the computing device is preserved and made available across sessions and devices through the user-specific cloud cache.

According to an aspect of an embodiment, synchronization further comprises propagating constraint representations stored in the one or more irreversible reservoirs from the computing device to the user-specific cloud cache through a non-invertible transfer operation that preserves constraint pattern identifiers usable for future admissibility screening while discarding reconstructable details of the inadmissible reasoning from which the constraint representations were derived, such that suppression artifacts accumulated during offline operation become available to govern subsequent admissibility evaluations conducted when the computing device is connected to the network, without exposing underlying inadmissible reasoning content through the synchronization channel.

According to an aspect of an embodiment, each thought stored in the thought cache carries admissibility metadata comprising one or more of a structural compatibility marker indicating geometric compatibility of the thought with classes of prompt contexts for which the thought has been successfully admitted, a contradiction history recording coherence failure conditions detected during prior reuse of the thought, a reuse success metric reflecting a proportion of prior reuse instances in which the thought satisfied admissibility evaluation and maintained coherent phase regime classification, a transformation limit indicating a degree of synthesis or modification the thought may undergo while remaining eligible for admissibility evaluation rather than automatic suppression, and a suppression proximity indicator reflecting closeness of the thought to constraint representations stored in the one or more irreversible reservoirs, wherein the admissibility metadata is updated following each admissibility evaluation and reuse event and is used to prioritize thought retrieval and guide synthesis decisions prior to admissibility evaluation.

### BRIEF DESCRIPTION OF THE DRAWING FIGURES

FIG. 1 is a block diagram illustrating an exemplary architecture of a mobile and distributed persistent cognitive system in which thought caching, thought retrieval, thought synthesis, and offline cognition are governed by an epistemic control architecture, according to an embodiment.

FIG. 2 is a block diagram illustrating an exemplary architecture of an epistemically governed multi-tier thought cache, according to an embodiment.

FIG. 3 is a flow diagram illustrating an exemplary admissibility-controlled retrieval and reuse pipeline through which a received prompt is processed, candidate thoughts are retrieved from a multi-tier thought cache, and each candidate thought is evaluated for epistemic admissibility prior to participation in response generation, according to an embodiment.

FIG. 4 is a flow diagram illustrating an exemplary governed synthesis and transformation pipeline, according to an embodiment.

FIG. 5 is a flow diagram illustrating an exemplary offline adaptation pipeline through which a prompt received by a computing device operating without network connectivity is processed using locally available cached thoughts, according to an embodiment.

FIG. 6 is a flow diagram illustrating an exemplary synchronization and thought promotion flow through which thoughts, epistemic metadata, admissibility evaluation history, and constraint representations accumulated on a computing device are synchronized with a user-specific cloud cache, according to an embodiment.

FIG. 7 is a flow diagram illustrating an exemplary resource-aware execution selection flow through which operational conditions of a computing device and epistemic risk characteristics of available candidate thoughts are jointly evaluated to select an execution profile governing thought selection preferences, according to an embodiment.

FIG. 8 is a flow diagram illustrating an exemplary output generation and expression control flow through which candidate response content received from an upstream governance pipeline is evaluated against admissibility status signals and coherence regime classifications, according to an embodiment.

FIG. 9 illustrates an exemplary computing environment on which an embodiment described herein may be implemented.

### DETAILED DESCRIPTION OF THE INVENTION

The inventor has conceived, and reduced to practice, a mobile and distributed persistent cognitive system governs cached thought retrieval, synthesis, and expression through an epistemic control architecture enforcing structural admissibility, coherence monitoring, and irreversible suppression across a multi-tier thought cache comprising local device, user-specific cloud, and global generalized storage tiers. Each candidate thought retrieved from the cache is evaluated for epistemic admissibility prior to participation in response generation, with denied thoughts projected into irreversible reservoirs through non-invertible operations that persistently exclude structurally similar reasoning from future retrieval and synthesis. Admitted thoughts are monitored for coherence during reasoning traversal and routed to graduated output modes comprising direct, qualified, partial, withheld, and deferred response expressions conditioned on epistemic provenance. When operating without network connectivity, the system adapts cached thoughts subject to the same epistemic governance regime and queues constraint artifacts for synchronization upon connectivity restoration. Execution profiles are jointly governed by resource state and epistemic risk.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “admissibility boundary” refers to a structural boundary within a latent manifold that separates regions in which reasoning trajectories are permitted from regions in which such trajectories are restricted or disallowed based on epistemic constraints.

As used herein, “almost-complex structure” refers to a tensor field on a latent manifold that assigns to each tangent space a linear map whose square equals negative identity, thereby defining canonical invariant two-dimensional planes and restricting admissible deformations of the manifold.

As used herein, “almost-Kähler compatibility” refers to a compatibility condition among a semantic metric, an almost-complex structure, and a symplectic form on a latent manifold, wherein the symplectic form is derived from the semantic metric and the almost-complex structure and remains closed under exterior differentiation.

As used herein, “barrier energy” refers to a computed energy associated with a boundary of a consolidated region, derived from one or more geometric quantities including epistemic curvature magnitude, extrinsic boundary curvature, or variation of a symplectic form across the boundary, the barrier energy quantifying resistance of the region to perturbation.

As used herein, “belief mass” refers to an abstract measure of representational commitment or compression associated with a region of a latent manifold.

As used herein, “boundary defect” refers to a localized event recorded at or near a reservoir boundary when a projected cognitive state exhibits epistemic curvature or phase inconsistency relative to an interior of a consolidated region.

As used herein, “capacity constraint” refers to a structural limitation on an amount of cognitive state density, belief mass, or representational compression that may be introduced into a region of a latent manifold without violating intrinsic geometric or epistemic limits of that region.

As used herein, “cognitive state” refers to a representational configuration corresponding to a location within a latent manifold and representing a hypothesis, belief, interpretation, or intermediate reasoning result.

As used herein, “cognitive trajectory” refers to a sequence of cognitive states corresponding to a path through a latent manifold, the path representing execution of a reasoning process.

As used herein, “coherence failure condition” refers to a detected condition during traversal of a cognitive trajectory indicating loss of epistemic coherence, including phase drift beyond a threshold, a phase discontinuity, or conflict among path-dependent descriptors.

As used herein, “configuration space” refers to a space of admissible geometric configurations of a latent manifold including at least a semantic metric, an almost-complex structure, a symplectic form, and an epistemic connection, subject to compatibility constraints.

As used herein, “consolidation stability” refers to a condition in which a consolidated region resists perturbations in semantic metric, epistemic connection, or symplectic structure within quantifiable bounds determined by curvature flatness and barrier energy.

As used herein, “consolidation transition” refers to a geometric phase transition in which a region of a latent manifold satisfies a flatness condition on epistemic curvature, exceeds a barrier energy threshold, and becomes classified as an irreversible reservoir.

As used herein, “degeneracy region” refers to a region of a latent manifold characterized by structural instability or elevated epistemic curvature such that reasoning within that region is unreliable or disallowed.

As used herein, “discrete epistemic curvature” refers to a curvature value computed on a discrete cognitive graph as a sum of edge phase values around a closed boundary path or simplicial face.

As used herein, “epistemic admissibility” refers to a structural determination, evaluated prior to or during reasoning execution, of whether a proposed cognitive state or trajectory is permitted to exist or be executed within an epistemically conditioned latent manifold.

As used herein, “epistemic coherence” refers to preservation of justificatory or evidential consistency along a cognitive trajectory, as measured by a path-dependent coherence quantity associated with transitions in the latent manifold.

As used herein, “epistemic conditioning” refers to embedding within a latent manifold structural constraints that govern admissibility, coherence, and capacity of reasoning trajectories independently of semantic similarity alone.

As used herein, “epistemic connection” refers to a geometric structure defined on transitions between cognitive states that assigns transition-specific coherence values and gives rise to a computable epistemic curvature over closed paths.

As used herein, “epistemic curvature” refers to a quantity computed from an epistemic connection over a closed path or local neighborhood of a latent manifold that measures cumulative evidential rotation or inconsistency.

As used herein, “epistemic line bundle” refers to a bundle structure over a latent manifold in which each manifold location carries an associated evidential state and in which parallel transport along manifold trajectories preserves magnitude while permitting phase rotation.

As used herein, “epistemic phase” refers to an accumulated path-dependent coherence quantity obtained by combining transition-specific coherence values along a cognitive trajectory.

As used herein, “evidential consistency function” refers to a function that assigns a scalar consistency value between two cognitive states based on one or more of source agreement, cross-modal corroboration, or temporal stability, the value being used to assign epistemic connection phases.

As used herein, “first Chern number” refers to a topological invariant computed from epistemic curvature over a closed two-dimensional surface in the latent manifold, representing a quantized measure of total epistemic curvature enclosed by the surface.

As used herein, “geometric phase transition” refers to a qualitative change in geometric structure of a latent manifold region characterized by collapse of epistemic curvature and stabilization of boundary energy, resulting in irreversible consolidation.

As used herein, “Gromov non-squeezing constraint” refers to a symplectic rigidity principle preventing compression of a region of a latent manifold below its intrinsic symplectic capacity.

As used herein, “hallucination” refers to execution or expression of a cognitive trajectory that is epistemically inadmissible within a conditioned latent manifold, regardless of semantic plausibility or syntactic fluency.

As used herein, “hallucination regime error” refers to operation of a cognitive system within a region or structural class of a latent manifold that violates epistemic admissibility constraints, such that resulting reasoning appears coherent but lacks structural legitimacy.

As used herein, “holonomy descriptor” refers to a path-dependent representation associated with a location in a latent manifold that encodes experiential distinctions arising from different prior trajectories that converge at that location.

As used herein, “irreversible reservoir” refers to a non-navigable storage structure configured to retain abstract constraint representations derived from epistemically inadmissible reasoning patterns or consolidated knowledge, or a consolidated region of a latent manifold satisfying phase flatness and barrier energy conditions, wherein contents of the reservoir influence future cognition through asymmetric feedback and are not modifiable by active reasoning.

As used herein, “J-anti-invariant component” refers to a portion of epistemic curvature incompatible with an almost-complex structure and associated with contradictory evidence.

As used herein, “J-invariant component” refers to a portion of epistemic curvature compatible with an almost-complex structure and associated with incomplete but internally consistent evidence.

As used herein, “latent manifold” refers to a geometric representational substrate in which cognitive states correspond to locations and reasoning processes correspond to trajectories through the space, the manifold encoding at least semantic relationships and, in certain embodiments, epistemic conditioning information.

As used herein, “learning readiness field” refers to a scalar field defined on a boundary of a consolidated region that quantifies energetic cost of extending the region in a given direction based on variation of geometric structures.

As used herein, “micro-holonomy screening” refers to evaluation of epistemic phase over short closed loops in a discrete cognitive graph to detect local epistemic inconsistencies during projection.

As used herein, “Nijenhuis tensor” refers to a tensor measuring failure of integrability of an almost-complex structure and serving as a measure of structural strain in regions undergoing geometric restructuring.

As used herein, “non-invertible projection” refers to an operation that maps a reasoning trajectory or class of trajectories to an abstract constraint representation while discarding reconstructable details of the original trajectory, such that the original trajectory cannot be regenerated from the projected representation.

As used herein, “path-dependent coherence quantity” refers to a value accumulated along transitions of a cognitive trajectory that reflects preservation or loss of epistemic grounding during traversal.

As used herein, “phase discontinuity” refers to a structural inconsistency detected during traversal of a cognitive trajectory indicating abrupt change in epistemic phase inconsistent with accumulated path-dependent descriptors.

As used herein, “phase flatness” refers to a condition in which epistemic curvature magnitude within a region remains below a flatness threshold, such that parallel transport of epistemic state within the region is approximately path-independent.

As used herein, “reasoning trajectory” refers to a cognitive trajectory computed by a cognitive system to evaluate, infer, or synthesize information within a latent manifold.

As used herein, “reservoir boundary” refers to a boundary of a consolidated irreversible reservoir that separates an interior region of epistemic flatness from an exterior region of higher curvature or instability and that may impose energetic or topological constraints on traversal.

As used herein, “reservoir-stratified state space” refers to a manifold region obtained by removing barrier neighborhoods associated with irreversible reservoirs, such that homotopy classes in the resulting space depend on consolidated knowledge content.

As used herein, “scaling vector” refers to a multi-component measure tracking semantic complexity, epistemic curvature budget, boundary energy distribution, and structural regularity of a latent manifold as cumulative experience increases.

As used herein, “semantic metric” refers to a geometric structure defined on a latent manifold that encodes semantic dissimilarity between cognitive states and determines geodesic distances and local neighborhood relationships.

As used herein, “symplectic capacity” refers to a quantity derived from a symplectic form on a latent manifold that defines an intrinsic volumetric or structural limit on admissible compression or accumulation of cognitive states within a region.

As used herein, “symplectic form” refers to a non-degenerate, closed bilinear form compatible with a semantic metric and an almost-complex structure that encodes structural capacity and area-like measures on a latent manifold.

As used herein, “symplectic rigidity” refers to geometric constraints imposed by a symplectic form that restrict allowable deformations and prevent reduction of intrinsic capacity of a region.

As used herein, “trajectory class” refers to a grouping of cognitive trajectories sharing a common structural pattern or admissibility characteristic, including trajectories mapped to a shared abstract constraint representation in an irreversible reservoir.

As used herein, “Wilson loop” refers to a discrete computation of epistemic phase around a closed loop in a cognitive graph obtained by multiplying or summing edge phase values assigned by an epistemic connection.

### Conceptual Architecture

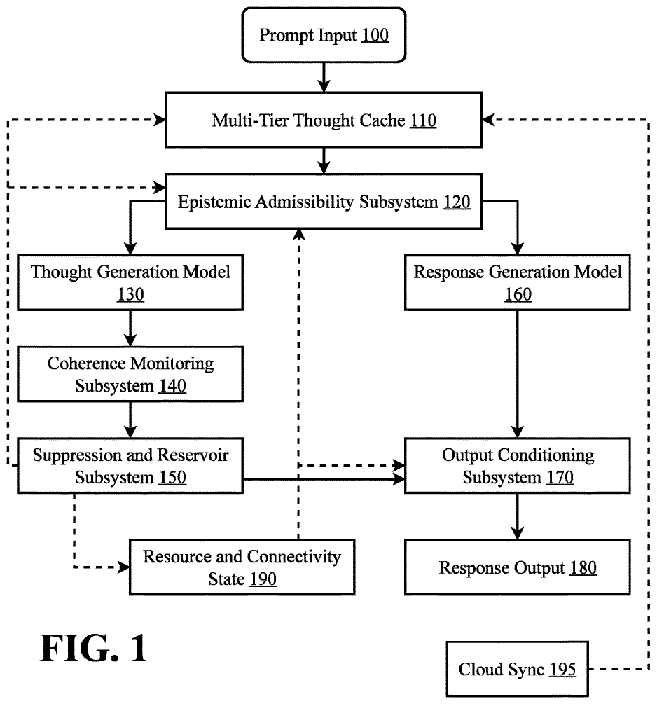

FIG. 1 is a block diagram illustrating an exemplary architecture of a mobile and distributed persistent cognitive system in which thought caching, thought retrieval, thought synthesis, and offline cognition are governed by an epistemic control architecture enforcing admissibility, coherence monitoring, and suppression before response generation and expression.

A prompt input subsystem 100 receives a prompt from a user of a computing device and initiates processing by forwarding the prompt to a multi-tier thought cache 110. The multi-tier thought cache 110 maintains a plurality of previously generated intermediate reasoning outputs, referred to herein as thoughts, organized across storage tiers that may include a local device cache, a user-specific cloud cache, and a global generalized thought cache. The multi-tier thought cache 110 retrieves one or more candidate thoughts relevant to the received prompt and forwards those candidate thoughts, together with the prompt, to an epistemic admissibility subsystem 120.

Epistemic admissibility subsystem 120 operates as a pre-execution governance gate and evaluates each candidate thought prior to its incorporation into response generation. Evaluation is performed based on one or more structural properties of an epistemically conditioned cognitive substrate maintained by the system, and may include assessment of structural compatibility of the candidate thought with the current prompt context, evaluation of capacity conditions associated with a region of the cognitive substrate corresponding to the candidate thought, screening for conflict between the candidate thought and constraint representations stored in one or more irreversible reservoirs, and evaluation of admissibility boundary conditions applicable to the candidate thought. Candidate thoughts satisfying epistemic admissibility are admitted for participation in response generation. Candidate thoughts that do not satisfy epistemic admissibility are denied admission, preventing their incorporation into any reasoning trajectory. The epistemic admissibility subsystem 120 routes admitted candidate thoughts along two paths: to a thought generation model 130 for use in generating additional thoughts when the admitted candidate thoughts do not fully address the prompt, and to a response generation model 160 for direct participation in response generation.

The thought generation model 130 comprises a first large language model configured to generate intermediate reasoning outputs from admitted candidate thoughts and the prompt. In embodiments, the thought generation model 130 is optimized for execution on resource-constrained computing devices. Thoughts generated by the thought generation model 130 are forwarded to a coherence monitoring subsystem 140, which operates as an in-execution governance layer tracking a path-dependent coherence quantity associated with reasoning involving the admitted candidate thoughts and detecting coherence failure conditions including phase drift beyond a threshold, phase discontinuity, or conflict among path-dependent descriptors. Upon detecting a coherence failure condition, the coherence monitoring subsystem 140 intervenes by interrupting, redirecting, or marking as inadmissible the reasoning trajectory in which the failure was detected. Thoughts that remain coherent following monitoring by the coherence monitoring subsystem 140 are forwarded to the response generation model 160 for incorporation into response generation.

The response generation model 160 comprises a second large language model configured to generate a response to the prompt from the admitted candidate thoughts and the prompt. In embodiments, the response generation model 160 has fewer parameters than the thought generation model 130. Results of response generation are forwarded by the response generation model 160 to an output conditioning subsystem 170.

A suppression and reservoir subsystem 150 operates as a post-execution governance layer and receives from the coherence monitoring subsystem 140 reasoning trajectories or candidate thoughts determined to be epistemically inadmissible. For each inadmissible trajectory or thought, the suppression and reservoir subsystem 150 generates a constraint representation characterizing a structural reason for the inadmissibility and projects that constraint representation into one or more irreversible reservoirs through a non-invertible operation that discards reconstructable details of the inadmissible reasoning while preserving information usable to identify structurally similar inadmissible patterns in subsequent thought retrieval and admissibility evaluations. The suppression and reservoir subsystem 150 provides asymmetric constraint feedback to the epistemic admissibility subsystem 120, depicted as a dashed feedback path along the left margin of the figure, such that constraint representations accumulated in the irreversible reservoirs persistently influence subsequent admissibility evaluations without being modifiable by active reasoning. The suppression and reservoir subsystem 150 additionally provides admissibility status signals to the output conditioning subsystem 170 reflecting the epistemic status of reasoning from which a candidate response is derived.

The output conditioning subsystem 170 receives admissibility status signals from the suppression and reservoir subsystem 150, coherence regime classifications from the coherence monitoring subsystem 140, and candidate response content from the response generation model 160, and conditions output generation on the epistemic admissibility status of the reasoning from which the candidate response is derived. The output conditioning subsystem 170 selects among a plurality of output modes including, but not limited to, a direct response mode, a qualified response mode, a partial response mode, and a deferred response mode based on the received admissibility and coherence signals, and forwards a conditioned response to a response output 180.

A resource and connectivity state subsystem 190 monitors operational conditions of the computing device including, but not limited to, at least one of battery level, available memory, and network connectivity state, and provides resource and connectivity state signals, depicted as dashed inputs, to the epistemic admissibility subsystem 120 and to the output conditioning subsystem 170. The resource and connectivity state signals influence execution profile selection, thought selection preferences, and output mode selection, such that epistemic governance operations are coordinated with available computational and network resources. When the computing device operates without network connectivity, the system adapts cached thoughts to address the received prompt subject to epistemic admissibility evaluation, coherence monitoring, and output conditioning as described above.

A cloud sync subsystem 195 maintains synchronization between the multi-tier thought cache 110 and remote cache tiers including a user-specific cloud cache and a global generalized thought cache, depicted as a dashed path along the right margin of the figure. Synchronization conducted by the cloud sync subsystem 195 encompasses not only thought content but also epistemic metadata, admissibility evaluation history, coherence regime classifications, and constraint representations derived from the irreversible reservoirs, such that governance state accumulated during operation is preserved across sessions and propagated to remote tiers when connectivity is available. The suppression and reservoir subsystem 150 additionally provides a dashed feedback path to the multi-tier thought cache 110 to update the epistemic status of cached thoughts based on admissibility and coherence outcomes accumulated during operation.

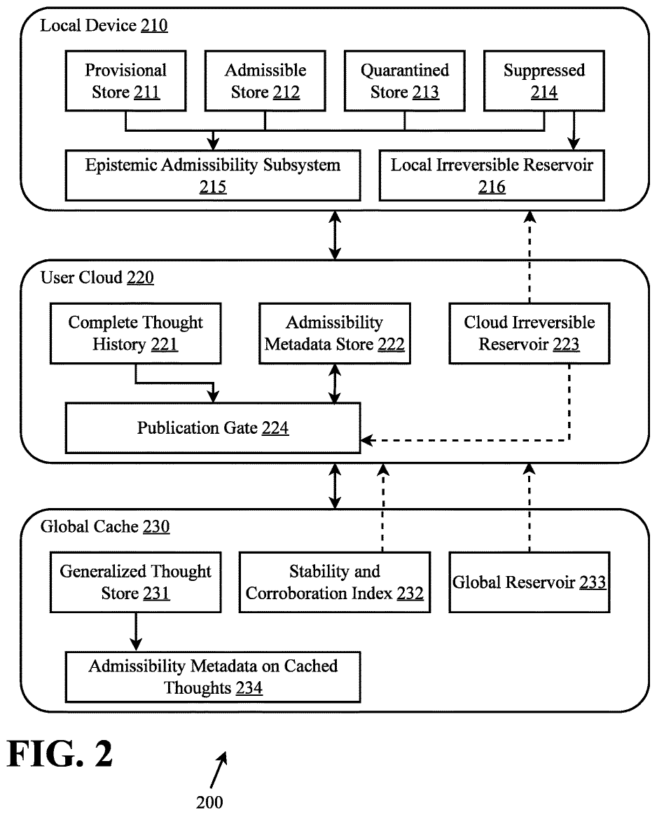

FIG. 2 is a block diagram illustrating an exemplary architecture of an epistemically governed multi-tier thought cache 200 in which cached thoughts are organized and governed according to both a storage tier and an epistemic status tier, and in which thought promotion, demotion, publication, and suppression are conditioned on admissibility evaluation, coherence history, and constraint representations maintained in irreversible reservoirs across all three tiers.

The multi-tier thought cache 200 comprises three storage tiers arranged in a hierarchy from a local device cache 210 at the uppermost tier through a user-specific cloud cache 220 at an intermediate tier to a global generalized thought cache 230 at a lowermost tier. Each tier maintains its own epistemic governance structures, and thoughts are promoted between tiers subject to epistemic criteria that become progressively more stringent as thoughts advance toward the global tier.

The local device cache 210 is stored on the computing device and organizes cached thoughts across four epistemic status stores. A provisional store 211 receives newly generated or newly retrieved candidate thoughts that have not yet undergone epistemic admissibility evaluation. A candidate thought residing in the provisional store 211 is forwarded to an epistemic admissibility subsystem 215 for evaluation prior to participation in any response generation. The epistemic admissibility subsystem 215 evaluates each candidate thought based on one or more structural properties of an epistemically conditioned cognitive substrate maintained by the system, and routes each evaluated thought to one of the remaining epistemic status stores based on the outcome of that evaluation. Candidate thoughts satisfying admissibility criteria are routed to an admissible store 212 and become eligible for retrieval and reuse in response generation. Candidate thoughts exhibiting structural compatibility issues or coherence failure conditions during prior reuse are routed to a quarantined store 213 and are excluded from response generation pending further evaluation or stabilization. Candidate thoughts determined to be epistemically inadmissible are routed to a suppressed store 214, from which a constraint representation characterizing the structural reason for inadmissibility is projected into a local irreversible reservoir 216 through a non-invertible operation. The local irreversible reservoir 216 provides asymmetric constraint feedback, depicted as a dashed path, to the epistemic admissibility subsystem 215, such that constraint representations accumulated from prior inadmissible thoughts persistently influence subsequent admissibility evaluations conducted within the local device cache 210 without being modifiable by active reasoning or response generation. The epistemic status of each thought within the local device cache 210 is maintained as admissibility metadata associated with the thought and is updated following each admissibility evaluation and reuse event.

The user-specific cloud cache 220 stores a complete thought history 221 for the user, encrypted with user-specific keys, together with an admissibility metadata store 222 recording epistemic evaluation history, coherence regime classifications, and reuse metrics associated with each stored thought. The user-specific cloud cache 220 further maintains a cloud irreversible reservoir 223 storing constraint representations propagated from the local irreversible reservoir 216 through a non-invertible synchronization operation. Synchronization between the local device cache 210 and the user-specific cloud cache 220 is depicted by bidirectional vertical arrows between the admissible store 212 and the complete thought history 221, indicating that thought content and associated epistemic metadata are transferred in both directions as connectivity permits, such that admissibility governance state accumulated during offline operation becomes available to govern subsequent evaluations conducted when the computing device is connected to the network.

A publication gate 224 within the user-specific cloud cache 220 governs promotion of thoughts from the user-specific cloud cache 220 to the global generalized thought cache 230. The publication gate 224 applies a dual-gate publication criterion requiring that a candidate thought satisfies both a privacy criterion comprising removal of user-identifying information and context, and an epistemic criterion comprising assessment of admissibility status, absence of matching constraint representations in the cloud irreversible reservoir 223, and stability of the thought under reuse across a plurality of contexts. The cloud irreversible reservoir 223 and a stability and corroboration index 232 of the global generalized thought cache 230 each provide dashed feedback paths to the publication gate 224, such that publication decisions are conditioned on both accumulated constraint history and corroborated reuse stability before a thought is admitted to the global tier.

The global generalized thought cache 230 stores abstracted reasoning patterns applicable across a plurality of users in a generalized thought store 231. A stability and corroboration index 232 associated with the global generalized thought cache 230 records corroboration history and reuse stability metrics for each generalized thought, enabling the system to assess whether a thought has demonstrated consistent admissibility across diverse reuse contexts. A global irreversible reservoir 233 maintains constraint representations propagated from the cloud irreversible reservoir 223, depicted as a dashed continuation of the right-margin synchronization path, and provides feedback to the publication gate 224 to prevent publication of thoughts that match globally accumulated inadmissibility patterns. A global irreversible reservoir 233 thereby ensures that constraint representations derived from inadmissible reasoning at the local or user tier propagate to govern publication and reuse at the global tier without exposing underlying inadmissible reasoning content through the synchronization channel.

An admissibility metadata on cached thoughts block 234 at the base of the figure represents the epistemic metadata structure associated with thoughts stored across all three tiers of the multi-tier thought cache 200. The admissibility metadata comprises one or more of compatibility markers indicating geometric compatibility of the thought with classes of prompt contexts for which the thought has been successfully admitted, contradiction history recording coherence failure conditions detected during prior reuse, reuse success metrics reflecting the proportion of prior reuse instances in which the thought satisfied admissibility evaluation and maintained coherent phase regime classification, transformation limits indicating the degree of synthesis or modification the thought may undergo while remaining eligible for admissibility evaluation, and suppression proximity indicators reflecting closeness of the thought to constraint representations stored in the irreversible reservoirs. The admissibility metadata is updated following each admissibility evaluation and reuse event across all tiers and is used to prioritize thought retrieval, guide synthesis decisions, and condition publication gate evaluations throughout the multi-tier thought cache 200.

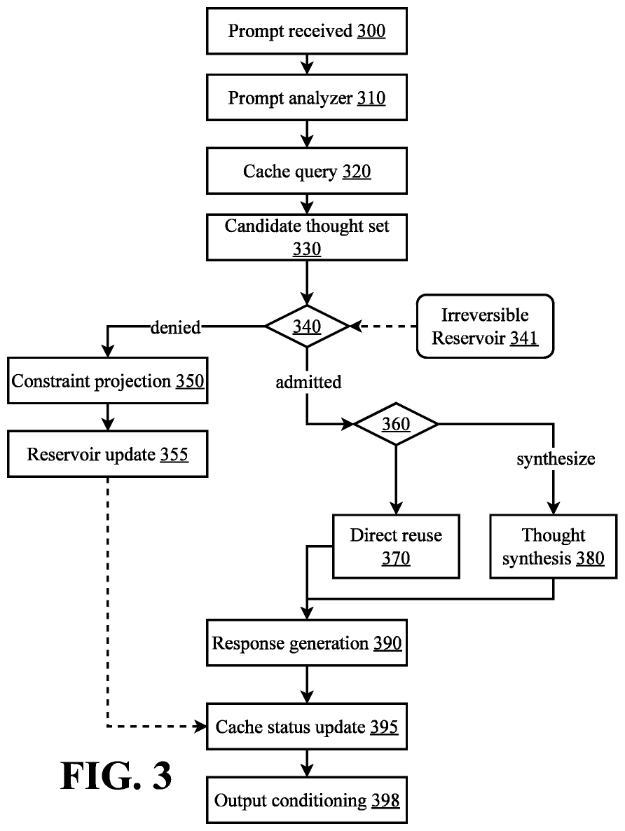

FIG. 3 is a flow diagram illustrating an exemplary admissibility-controlled retrieval and reuse pipeline through which a received prompt is processed, candidate thoughts are retrieved from a multi-tier thought cache, each candidate thought is evaluated for epistemic admissibility prior to participation in response generation, denied thoughts are routed to constraint projection and irreversible reservoir update, and admitted thoughts are routed through either direct reuse or governed synthesis before response generation and output conditioning.

Processing within the pipeline is initiated upon receipt of a prompt at a prompt received stage 300. The received prompt is forwarded to a prompt analyzer 310, which analyzes the prompt to identify key concepts, requirements, and contextual attributes relevant to candidate thought retrieval. The prompt analyzer 310 produces a structured representation of the prompt that is used to query the multi-tier thought cache in a cache query stage 320. The cache query 320 retrieves candidate thoughts from one or more tiers of the multi-tier thought cache based on relevance to the key concepts and contextual attributes identified by the prompt analyzer 310, drawing from the local device cache, the user-specific cloud cache, and the global generalized thought cache as availability and connectivity permit. Retrieved candidate thoughts are assembled into a candidate thought set 330 and forwarded to an admissibility evaluation stage 340.

The admissibility evaluation 340 operates as the primary governance gate of the pipeline and evaluates each candidate thought in the candidate thought set 330 prior to its incorporation into any reasoning trajectory or response generation operation. Evaluation is performed based on one or more structural properties of an epistemically conditioned cognitive substrate maintained by the system and may encompass assessment of structural compatibility of the candidate thought with the current prompt context, evaluation of capacity conditions associated with a region of the cognitive substrate corresponding to the candidate thought, and screening for conflict between the candidate thought and constraint representations maintained in an irreversible reservoir 341. The irreversible reservoir 341 provides constraint pattern indices to the admissibility evaluation 340 via a dashed feedback path, such that constraint representations accumulated from prior inadmissible reasoning persistently narrow the set of candidate thoughts eligible for admission without requiring reconstruction of the original inadmissible reasoning. Each candidate thought in the candidate thought set 330 receives an admission outcome of either admitted or denied based on the results of the admissibility evaluation 340.

Candidate thoughts receiving a denied outcome are routed along the left branch of the figure to a constraint projection stage 350. The constraint projection 350 generates a constraint representation characterizing the structural reason for inadmissibility of the denied candidate thought and applies a non-invertible operation to the constraint representation that discards reconstructable details of the inadmissible thought while preserving information sufficient to identify structurally similar inadmissible patterns in subsequent retrieval and admissibility evaluations. The projected constraint representation is forwarded to a reservoir update stage 355, which incorporates the constraint representation into the irreversible reservoir 341 and propagates a dashed update path to a cache status update 395, triggering a refresh of the epistemic metadata associated with the denied thought in the multi-tier thought cache to reflect the suppressed status and updated suppression proximity indicators resulting from the inadmissibility determination.

Candidate thoughts receiving an admitted outcome are routed downward to a reuse routing stage 360, which determines whether each admitted thought may be directly incorporated into response generation or whether synthesis or transformation is required to address the received prompt. The reuse routing 360 evaluates the correspondence between the admitted candidate thoughts and the requirements of the received prompt as identified by the prompt analyzer 310 and selects between two processing paths. Admitted thoughts that sufficiently address the prompt without modification are routed along the left sub-branch to a direct reuse stage 370, in which the admitted thought participates in response generation without further transformation. Admitted thoughts that partially address the prompt or that require combination with other thoughts to fully address the prompt requirements are routed along the right sub-branch to a thought synthesis stage 380, in which one or more admitted thoughts are combined or transformed to produce a synthesized candidate thought. The thought synthesis 380 subjects each synthesized candidate thought to admissibility re-evaluation prior to incorporating the synthesized thought into response generation, ensuring that synthesis operations do not introduce inadmissible reasoning patterns that were not present in the constituent admitted thoughts. Both the direct reuse 370 and thought synthesis 380 paths converge at a response generation stage 390.

The response generation 390 generates a candidate response to the received prompt from the admitted and routed thoughts. Coherence monitoring remains active during response generation 390, tracking a path-dependent coherence quantity associated with reasoning involving the admitted thoughts and detecting coherence failure conditions as described with reference to other figures herein. Results of response generation 390 are forwarded to the cache status update 395, which refreshes the epistemic metadata associated with all candidate thoughts participating in the response generation 390 to reflect admissibility evaluation outcomes, coherence regime classifications observed during response generation, and reuse success metrics accumulated from the current processing cycle. Updated epistemic metadata is written back to the multi-tier thought cache to condition subsequent retrieval and admissibility evaluations involving the same thoughts.

The cache status update 395 forwards the conditioned response and associated epistemic status signals to an output conditioning stage 398, which selects an output mode based on the epistemic admissibility status and coherence regime classification of the reasoning from which the candidate response is derived. The output conditioning 398 produces a direct response when the candidate response is supported by admitted thoughts that maintained coherent phase regime classification throughout response generation, a qualified response when the candidate response is derived from synthesized or transformed thoughts or from thoughts that required corroboration during coherence monitoring, or a deferred response when no epistemically admissible reasoning trajectory supports generation of a response and connectivity restoration or additional context is required to proceed.

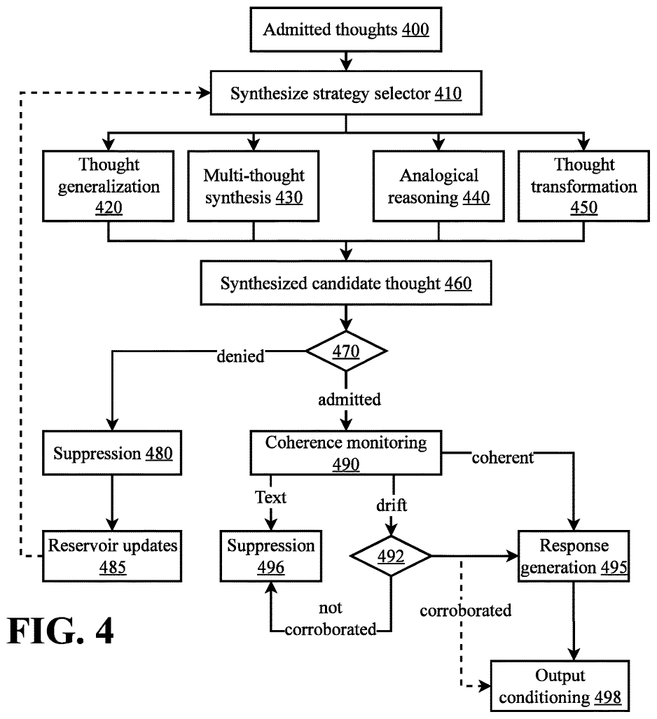

FIG. 4 is a flow diagram illustrating an exemplary governed synthesis and transformation pipeline through which admitted thoughts that do not directly address a received prompt are processed using one or more synthesis or transformation strategies, each resulting synthesized candidate thought is subjected to admissibility re-evaluation and coherence monitoring, and outcomes are routed to either response generation with appropriate output conditioning or suppression with irreversible reservoir update.

The pipeline is entered from admitted thoughts 400 that have satisfied epistemic admissibility evaluation as described herein but for which no direct cache match is available to fully address the received prompt. The admitted thoughts are forwarded to a synthesis strategy selector 410, which evaluates the requirements of the received prompt as identified by a prompt analyzer and the admissibility metadata associated with the admitted thoughts to select one or more synthesis or transformation strategies appropriate to the relationship between the admitted thoughts and the prompt requirements. The synthesis strategy selector 410 routes processing to one or more of four strategy blocks operating in parallel or in sequence depending on the characteristics of the available admitted thoughts and the prompt requirements.

A thought generalization strategy 420 receives one or more admitted thoughts containing specific examples or narrowly scoped reasoning patterns and extracts underlying principles and abstractions applicable more broadly to the requirements of the received prompt. The thought generalization 420 produces a generalized candidate thought encoding a reasoning pattern of wider applicability than the constituent admitted thoughts from which it is derived. A multi-thought synthesis strategy 430 receives a plurality of admitted thoughts that are individually insufficient to address the prompt requirements and combines complementary components across those thoughts, resolving conflicts and establishing conceptual connections to construct a composite candidate thought that more fully addresses the prompt requirements than any constituent thought individually. An analogical reasoning strategy 440 receives one or more admitted thoughts originating in a domain different from the domain of the received prompt and maps relational structures between the source domain of the admitted thoughts and the target domain of the received prompt, producing a candidate thought that transfers reasoning patterns across conceptual boundaries. A thought transformation strategy 450 receives one or more admitted thoughts and applies controlled parameter adjustments including perspective shifting, terminology adaptation, and constraint modification to align the admitted thoughts with the specific requirements of the received prompt, producing a transformed candidate thought. Each of the four strategy blocks 420, 430, 440, and 450 produces a candidate thought that is forwarded to a synthesized candidate thought stage 460, at which the outputs of all active strategy branches are consolidated for subsequent epistemic evaluation.

The synthesized candidate thought 460 is forwarded to an admissibility re-evaluation stage 470, which subjects the synthesized candidate thought to the same structural epistemic evaluation applied to retrieved candidate thoughts during initial admissibility screening. The admissibility re-evaluation 470 evaluates structural compatibility of the synthesized candidate thought with the current prompt context, assesses capacity conditions of the epistemically conditioned cognitive substrate associated with the synthesized thought, and screens the synthesized thought for conflict with constraint representations maintained in an irreversible reservoir. The irreversible reservoir provides constraint pattern indices to the admissibility re-evaluation 470 via a dashed feedback path, such that constraint representations accumulated from prior inadmissible synthesis attempts persistently exclude structurally similar synthesized thoughts from admission without requiring reconstruction of the original inadmissible synthesis. The admissibility re-evaluation 470 produces either an admitted or denied outcome for the synthesized candidate thought.

Synthesized candidate thoughts receiving a denied outcome are routed along the left branch to a suppression stage 480, which generates a constraint representation characterizing the structural reason for inadmissibility of the synthesized candidate thought and applies a non-invertible projection operation to that constraint representation. The projected constraint representation is forwarded to a reservoir update stage 485, which incorporates the constraint representation into the irreversible reservoir. The reservoir update 485 additionally propagates a dashed feedback path back to the synthesis strategy selector 410, such that inadmissibility outcomes from prior synthesis attempts narrow the strategy space available for subsequent synthesis by excluding strategy and thought combinations that have been determined to produce inadmissible results.

Synthesized candidate thoughts receiving an admitted outcome are forwarded to a coherence monitoring stage 490, which tracks a path-dependent coherence quantity associated with reasoning involving the synthesized candidate thought during traversal and classifies the reasoning into one of three phase regimes based on the magnitude of the accumulated coherence quantity. Reasoning classified into a coherent regime, in which the path-dependent coherence quantity remains below a first threshold, is routed directly to a response generation stage 495. Reasoning classified into a drift regime, in which the path-dependent coherence quantity exceeds the first threshold but remains below a second threshold, is routed to a corroboration required stage 492, at which the system seeks an independent reasoning path that reaches a substantially similar conclusion while maintaining the path-dependent coherence quantity within the coherent regime and that is not deformable into the original reasoning path within the epistemically conditioned cognitive substrate. When corroboration is achieved, the corroborated reasoning is forwarded to the response generation stage 495 along a path that additionally signals the output conditioning stage 498 that the response is derived from corroborated rather than directly coherent synthesis, triggering selection of a qualified output mode. When corroboration is not achieved, the reasoning is routed to a suppression stage 496 for constraint projection. Reasoning classified into an inversion regime, in which the path-dependent coherence quantity meets or exceeds the second threshold, is routed directly to the suppression stage 496 without seeking corroboration.

The suppression stage 496 receives inadmissible reasoning from both the inversion regime branch and the not-corroborated branch of the drift regime and generates constraint representations for each, projecting those representations into the irreversible reservoir infrastructure through non-invertible operations as described above.

The response generation stage 495 generates a candidate response from synthesized candidate thoughts that have passed admissibility re-evaluation and maintained coherent or corroborated phase regime classification during coherence monitoring. The candidate response is forwarded to an output conditioning stage 498, which selects an output mode conditioned on the epistemic admissibility status and coherence regime classification of the reasoning from which the candidate response is derived. The output conditioning 498 produces a direct response when the candidate response is supported by synthesized thoughts that satisfied admissibility re-evaluation and maintained coherent phase regime classification throughout response generation, a qualified response when the candidate response is derived from corroborated synthesis or from thoughts that required drift-regime corroboration during coherence monitoring, or a deferred response when no epistemically admissible and coherent or corroborated synthesis path supports generation of a response. The dashed path from the corroboration route to the output conditioning 498 reflects that the qualification status of the output is determined not only by the admissibility of the synthesized thought but also by the coherence regime in which corroboration was achieved.

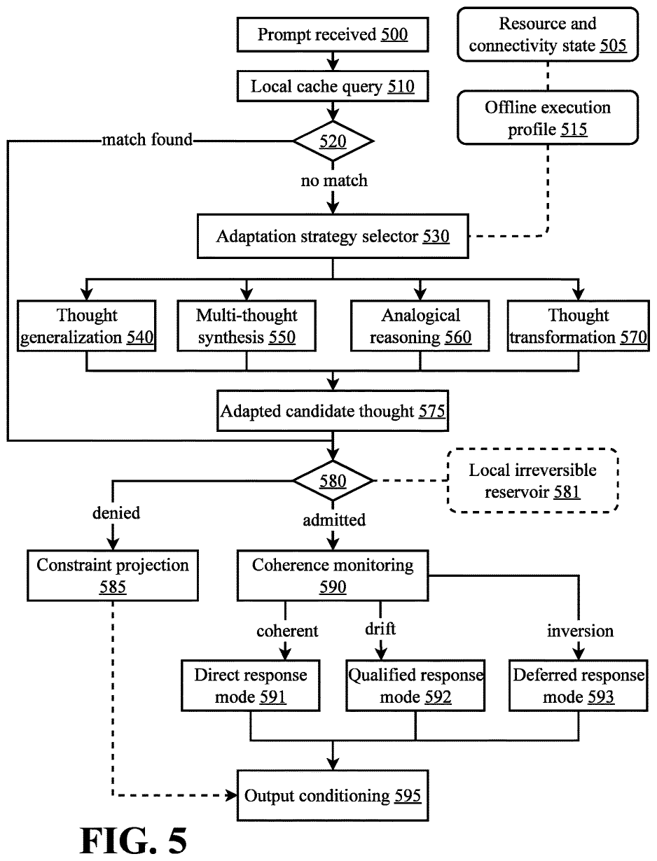

FIG. 5 is a flow diagram illustrating an exemplary offline adaptation pipeline through which a prompt received by a computing device operating without network connectivity is processed using locally available cached thoughts, adapted through one or more offline adaptation strategies subject to resource state and epistemic risk weighting, evaluated for epistemic admissibility against locally maintained irreversible reservoirs, monitored for coherence during reasoning, and resolved into one of a plurality of graduated output modes conditioned on the epistemic status of the adapted reasoning, with constraint projections queued for synchronization upon restoration of network connectivity.

The pipeline is entered upon receipt of a prompt at a prompt received stage 500 under conditions in which the computing device lacks network connectivity, such that candidate thought retrieval is restricted to locally stored thoughts and remote cache tiers are unavailable for the duration of processing. A resource and connectivity state subsystem 505 monitors operational conditions of the computing device including battery level, available memory, and network connectivity state and provides resource and connectivity state signals via a dashed input path to an offline execution profile 515, which conditions the execution of subsequent stages based on available computational resources and the epistemic risk profile of locally available candidate thoughts. The received prompt is forwarded to a local cache query stage 510, which queries the local device cache for candidate thoughts relevant to the received prompt, drawing exclusively from the admissible store and the generalized store of the local device cache as described herein. The offline execution profile 515 provides a dashed governance signal to an adaptation strategy selector 530 reflecting the resource state of the computing device and the epistemic risk level associated with locally available candidate thoughts, such that strategy selection is conditioned on both computational availability and the admissibility history of candidate thoughts available for adaptation.

The locally retrieved candidate thoughts are forwarded from the local cache query 510 to a direct match check 520, which evaluates whether any retrieved candidate thought satisfies admissibility screening and sufficiently addresses the prompt requirements without requiring synthesis or transformation. The direct match check 520 applies admissibility screening to each candidate thought as described herein. When a direct match is found, processing is routed along the right margin of the figure directly to a response generation stage, bypassing the adaptation strategy selector 530 and the adaptation strategy blocks, such that the system preferentially employs highly validated admissible cached thoughts over adapted thoughts under constrained resource and connectivity conditions. When no direct match is found, processing is routed downward to the adaptation strategy selector 530.

The adaptation strategy selector 530 receives the prompt requirements, the admissibility metadata associated with available candidate thoughts, and the governance signal from the offline execution profile 515, and selects one or more adaptation strategies weighted by resource state and epistemic risk. Under conditions of low battery level or elevated epistemic risk, the adaptation strategy selector 530 preferentially selects strategies operating on thoughts of higher admissibility status and avoids strategies requiring extensive synthesis across thoughts of lower or unverified admissibility. The adaptation strategy selector 530 routes processing to one or more of four strategy blocks. A thought generalization strategy 540 extracts underlying principles from one or more admitted thoughts to produce a generalized candidate thought of wider applicability. A multi-thought synthesis strategy 550 combines complementary components from a plurality of admitted thoughts to construct a composite candidate thought addressing the prompt requirements. An analogical reasoning strategy 560 maps relational structures from the domain of one or more admitted thoughts to the domain of the received prompt to produce a candidate thought transferring reasoning patterns across conceptual boundaries. A thought transformation strategy 570 applies controlled parameter adjustments to one or more admitted thoughts to align them with the specific requirements of the received prompt. Each active strategy block produces a candidate thought that is forwarded to an adapted candidate thought stage 575, at which the outputs of all active strategy branches are consolidated for subsequent epistemic evaluation.

The adapted candidate thought 575 is forwarded to an admissibility evaluation stage 580, which subjects the adapted candidate thought to structural epistemic evaluation based on properties of the epistemically conditioned cognitive substrate maintained locally on the computing device. The admissibility evaluation 580 applies local irreversible reservoir screening via a dashed feedback path from a local irreversible reservoir 581, such that constraint representations accumulated from prior inadmissible reasoning during both online and offline operation persistently exclude structurally similar adapted thoughts from admission. Adapted candidate thoughts receiving a denied outcome are routed along the left branch to a constraint projection stage 585, which generates a constraint representation characterizing the structural reason for inadmissibility and applies a non-invertible projection operation that discards reconstructable details while preserving constraint pattern identifiers. The constraint projection 585 marks the projected constraint representation as queued for synchronization, such that the constraint artifact will be propagated to the user-specific cloud cache and cloud irreversible reservoir upon restoration of network connectivity without requiring immediate cloud access to complete the local governance operation. Adapted candidate thoughts receiving an admitted outcome are routed downward to a coherence monitoring stage 590.

The coherence monitoring stage 590 tracks a path-dependent coherence quantity associated with reasoning involving the admitted adapted candidate thought and classifies the reasoning into one of three phase regimes based on the magnitude of the accumulated coherence quantity. The three phase regime outcomes of the coherence monitoring 590 are resolved into three corresponding output mode branches that together constitute the graduated output mode selection characteristic of offline operation under epistemic governance. Reasoning classified into a coherent regime is routed to a direct response mode 591, in which a response is generated from the admitted adapted thought without qualification, reflecting that the adapted reasoning maintained full epistemic coherence throughout traversal. Reasoning classified into a drift regime is routed to a qualified response mode 592, in which a response is generated from the admitted adapted thought accompanied by an indication that the response is derived from adapted rather than directly admissible cached content and that the reasoning exhibited phase drift requiring acknowledgment in the expressed output. Reasoning classified into an inversion regime is routed to a deferred response mode 593, in which response generation is withheld and the system produces an indication that no epistemically admissible and coherent adapted reasoning path is available to support a response under current offline conditions, together with an indication that connectivity restoration may enable retrieval of higher-admissibility candidate thoughts from remote cache tiers.

The direct response mode 591, qualified response mode 592, and deferred response mode 593 each forward their respective outputs to an output conditioning stage 595, which produces a conditioned response or response indication appropriate to the selected output mode. The output conditioning 595 additionally receives a dashed path from the constraint projection stage 585 reflecting the queued synchronization status of constraint artifacts generated during the current offline processing cycle, and incorporates an indication that synchronization of epistemic governance state is pending connectivity restoration where relevant to the expressed output. Upon restoration of network connectivity, queued constraint projections and updated epistemic metadata accumulated during offline operation are propagated to the user-specific cloud cache and cloud irreversible reservoir through the synchronization architecture described herein, ensuring that governance state developed during offline operation becomes available to condition subsequent admissibility evaluations conducted when the computing device is connected to the network.

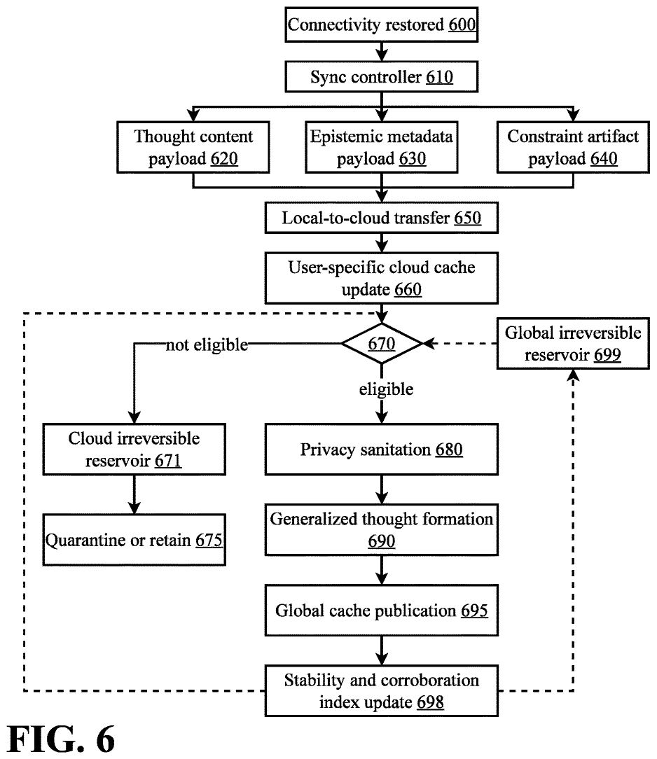

FIG. 6 is a flow diagram illustrating an exemplary synchronization and thought promotion flow through which thoughts, epistemic metadata, admissibility evaluation history, and constraint representations accumulated on a computing device are synchronized with a user-specific cloud cache upon restoration of network connectivity or upon a periodic synchronization trigger, and through which thoughts satisfying a dual-gate publication criterion are promoted from the user-specific cloud cache to the global generalized thought cache subject to privacy sanitization, epistemic eligibility assessment, and stability corroboration, with governance state propagated across all tiers through the synchronization channel.

The flow is initiated at a connectivity restored stage 600 representing either the restoration of network connectivity following a period of offline operation as described herein, or the occurrence of a periodic synchronization trigger during connected operation. Upon initiation, processing is forwarded to a sync controller 610, which orchestrates the synchronization sequence by assembling synchronization payloads and ordering their transfer according to a priority ordering based on the epistemic admissibility status of the content to be synchronized. The sync controller 610 prioritizes transfer of high-admissibility thoughts and suppression artifacts over low-confidence speculative content, such that the most epistemically valuable governance state is propagated to remote tiers first in the event that connectivity is interrupted before synchronization is complete. The sync controller 610 distributes synchronization content across three parallel payload assembly branches.

A thought content payload 620 assembles the thought content to be transferred from the local device cache to the user-specific cloud cache, comprising thoughts of admissible epistemic status together with associated reasoning structures accumulated since the preceding synchronization event. An epistemic metadata payload 630 assembles the admissibility evaluation history, coherence regime classifications, reuse success metrics, contradiction history, and other admissibility metadata associated with each thought included in the thought content payload 620, such that the epistemic governance state accumulated during local operation is transferred alongside the thought content it describes rather than as a separate or subsequent operation. A constraint artifact payload 640 assembles the constraint representations generated during local operation and queued for synchronization, comprising non-invertible projections of inadmissible reasoning patterns accumulated during both online and offline processing cycles since the preceding synchronization event. The three payloads assembled by the thought content payload 620, epistemic metadata payload 630, and constraint artifact payload 640 stages are forwarded to a local-to-cloud transfer stage 650.

The local-to-cloud transfer 650 conducts transfer of the assembled payloads to the user-specific cloud cache, applying a non-invertible transfer operation to the constraint artifact payload 640 such that constraint pattern identifiers usable for future admissibility screening are preserved in the transferred representation while reconstructable details of the inadmissible reasoning from which the constraint artifacts were derived are discarded, thereby ensuring that inadmissible reasoning content is not exposed through the synchronization channel. Thought content and epistemic metadata are transferred without modification to their content, subject to encryption with user-specific keys maintained by the user-specific cloud cache. The local-to-cloud transfer 650 forwards the transferred content to a user-specific cloud cache update stage 660.

The user-specific cloud cache update 660 incorporates the transferred thought content, epistemic metadata, and constraint representations into the user-specific cloud cache, updating the complete thought history, admissibility metadata store, and cloud irreversible reservoir of the user-specific cloud cache as described herein. A cloud-to-local sync path represents the reciprocal direction of synchronization through which thoughts, epistemic metadata, and constraint representations present in the user-specific cloud cache but not yet available on the local device are transferred to the local device cache, such that governance state accumulated across sessions and devices is made available to condition local admissibility evaluations. Following completion of the cloud cache update, the updated thought history and admissibility metadata are forwarded to a publication eligibility assessment stage 670.

The publication eligibility assessment 670 evaluates each thought in the updated user-specific cloud cache for eligibility for promotion to the global generalized thought cache by applying a dual-gate publication criterion. The dual-gate criterion requires concurrent satisfaction of a privacy criterion and an epistemic criterion. The privacy criterion requires removal of user-identifying information and context from the candidate thought. The epistemic criterion requires that the candidate thought satisfies at least one of a minimum epistemic status tier, an absence of matching constraint representations in a cloud irreversible reservoir 671, a history of admissibility-consistent reuse across a plurality of contexts, and a contradiction measure below a publication threshold. The cloud irreversible reservoir 671 provides constraint pattern indices to the publication eligibility assessment 670, such that constraint representations accumulated from prior inadmissible reasoning at the user tier persistently exclude structurally similar thoughts from global publication. A global irreversible reservoir 699 additionally provides a dashed feedback path to the publication eligibility assessment 670 via the right margin of the figure, such that constraint representations accumulated at the global tier further condition publication eligibility independently of user-tier constraint history. Thoughts that do not satisfy the dual-gate publication criterion are routed along the left branch to a quarantine or retain stage 675, at which such thoughts are retained within the user-specific cloud cache only and assigned a quarantined epistemic status pending accumulation of additional admissibility evidence or resolution of identified epistemic deficiencies. Thoughts satisfying the dual-gate publication criterion are routed downward to a privacy sanitization stage 680.

The privacy sanitization 680 applies user-identifying information removal to the eligible candidate thought, extracting underlying reasoning patterns while removing personal context, user-specific references, and identifying attributes, to produce a sanitized candidate thought suitable for sharing across users. The sanitized candidate thought is forwarded to a generalized thought formation stage 690, which abstracts the sanitized reasoning pattern into a generalized thought structure encoding reasoning applicable across a plurality of users and prompt contexts. The generalized thought 690 is forwarded to a global cache publication stage 695, which incorporates the generalized thought into the global generalized thought cache and updates a stability and corroboration index 698 to record the publication event and initialize corroboration tracking for the newly published thought.

The stability and corroboration index update 698 maintains corroboration history and reuse stability metrics for each generalized thought published to the global generalized thought cache and provides two dashed feedback paths governing subsequent publication eligibility and global reservoir state. A first dashed feedback path returns along the left margin of the figure from the stability and corroboration index update 698 to the publication eligibility assessment 670, such that the corroboration history and stability metrics accumulated for previously published generalized thoughts condition the publication eligibility of subsequently submitted candidate thoughts, requiring that thoughts demonstrate stability under reuse across diverse contexts before further promotion. A second dashed feedback path propagates from the stability and corroboration index update 698 along the right margin to the global irreversible reservoir 699, updating the global reservoir with constraint representations derived from generalized thoughts that exhibit instability or contradiction during corroboration monitoring, such that globally accumulated inadmissibility evidence is maintained in the global irreversible reservoir 699 and made available to condition publication eligibility assessments for all users through the feedback path described above.

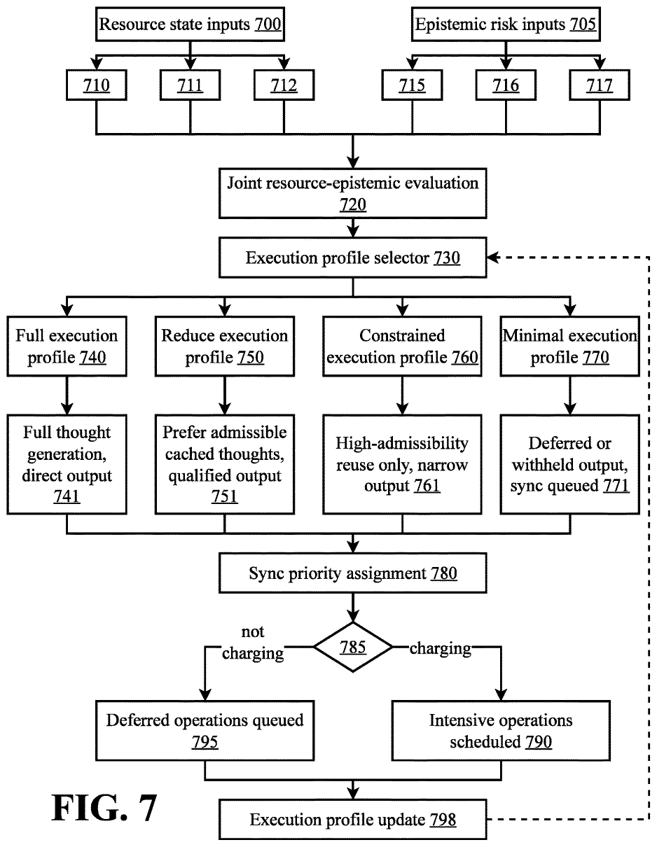

FIG. 7 is a flow diagram illustrating an exemplary resource-aware execution selection flow through which operational conditions of a computing device and epistemic risk characteristics of available candidate thoughts are jointly evaluated to select an execution profile governing thought selection preferences, adaptation strategy availability, output mode eligibility, and synchronization priority for a subsequent processing cycle, and through which intensive governance operations are scheduled based on charging state to preserve battery resources while maintaining epistemic reliability.

The flow receives inputs from two parallel input columns representing distinct but complementary governance dimensions. A resource state inputs block 700 assembles operational condition measurements from the computing device comprising a battery level 710 reflecting current power availability, an available memory 711 reflecting current computational capacity, and a network state 712 reflecting current connectivity status. An epistemic risk inputs block 705 assembles epistemic risk characteristics of candidate thoughts available for retrieval and reuse comprising an admissibility status 715 reflecting the epistemic status tier assigned to available candidate thoughts as described herein, a coherence history 716 reflecting coherence regime classifications observed during prior reuse of available candidate thoughts, and a reservoir proximity 717 reflecting the closeness of available candidate thoughts to constraint representations stored in the irreversible reservoirs maintained by the system. The resource state inputs 700 and epistemic risk inputs 705 each distribute their respective measurements across the corresponding sub-blocks through downward branches and forward all assembled measurements to a joint resource-epistemic evaluation stage 720.

The joint resource-epistemic evaluation 720 combines the resource state measurements and epistemic risk characteristics into a composite risk and resource score reflecting both the computational capacity available to the computing device and the epistemic reliability of the candidate thoughts available for the current processing cycle. The composite score produced by the joint resource-epistemic evaluation 720 is forwarded to an execution profile selector 730, which maps the composite score to one of a plurality of execution profiles of decreasing capability and increasing epistemic conservatism. The execution profile selector 730 fans out to four execution profile blocks representing the range of execution conditions under which the system may operate.

A full execution profile 740 is selected when resource state measurements indicate sufficient battery level, available memory, and network connectivity, and epistemic risk inputs indicate that available candidate thoughts are of high admissibility status with low reservoir proximity and coherent reuse history. Under the full execution profile 740, the system applies full thought generation capability, conducts complete admissibility evaluation and coherence monitoring across all available candidate thoughts, and produces a direct response output as indicated by a full thought generation and direct output outcome block 741. A reduced execution profile 750 is selected when resource state measurements indicate moderate resource availability or when epistemic risk inputs indicate that available candidate thoughts are of mixed admissibility status or exhibit elevated reservoir proximity. Under the reduced execution profile 750, the system preferentially selects candidate thoughts of higher admissibility status for reuse over generating new thoughts, reduces the complexity of synthesis operations, and produces qualified output reflecting the reduced epistemic confidence of the selected execution mode as indicated by a prefer admissible cached thoughts and qualified output outcome block 751. A constrained execution profile 760 is selected when resource state measurements indicate low battery level or limited available memory, or when epistemic risk inputs indicate that available candidate thoughts are predominantly of lower admissibility status or exhibit significant coherence failure history. Under the constrained execution profile 760, the system restricts thought reuse to candidate thoughts of the highest available admissibility status, narrows the scope of response generation to prompt requirements supportable by directly admissible cached thoughts, and produces a narrowed output reflecting the epistemic and resource constraints governing the current processing cycle as indicated by a high-admissibility reuse only and narrow output outcome block 761. A minimal execution profile 770 is selected when resource state measurements indicate critically low battery level or absence of network connectivity combined with epistemic risk inputs indicating that no candidate thoughts of sufficient admissibility status are locally available to support response generation. Under the minimal execution profile 770, the system defers or withholds response generation, queues synchronization operations for execution upon restoration of connectivity or charging, and produces a deferred or withheld output as indicated by a deferred or withheld output and sync queued outcome block 771.

The outcome blocks 741, 751, 761, and 771 associated with the four execution profiles converge at a sync priority assignment stage 780, which assigns synchronization priority ordering to thoughts, epistemic metadata, and constraint artifacts queued for transfer to the user-specific cloud cache. The sync priority assignment 780 prioritizes transfer of high-admissibility thoughts and suppression artifacts over low-confidence speculative content, such that the most epistemically valuable governance state is propagated to remote tiers first in the event that connectivity is interrupted before synchronization is complete, as described herein. The assigned sync priority ordering is forwarded to a charging state check 785.

The charging state check 785 evaluates whether the computing device is currently connected to a charging source and branches processing based on the result. When the computing device is connected to a charging source, processing is routed along the right branch to an intensive operations scheduled block 790, at which computationally intensive governance operations including full admissibility evaluation, thought generation, coherence monitoring across extended reasoning trajectories, and complete synchronization with remote cache tiers are scheduled for immediate or near-term execution, exploiting the availability of charging power to conduct operations that would be deferred under battery-constrained conditions. When the computing device is not connected to a charging source, processing is routed downward to a deferred operations queued block 795, at which computationally intensive governance operations are queued for deferred execution pending restoration of charging connectivity or network access, and lightweight operations supportable within current battery and memory constraints are permitted to proceed in accordance with the active execution profile.

The intensive operations scheduled block 790 and the deferred operations queued block 795 converge at an execution profile update stage 798, which refreshes the execution profile governing the subsequent processing cycle based on the scheduling and deferral decisions made during the current cycle. The execution profile update 798 propagates a dashed feedback path to the execution profile selector 730, such that the execution profile selector 730 incorporates the updated profile state into execution profile selection for the next processing cycle, enabling the system to adapt continuously to changing resource and epistemic risk conditions across successive interactions without requiring external reconfiguration.

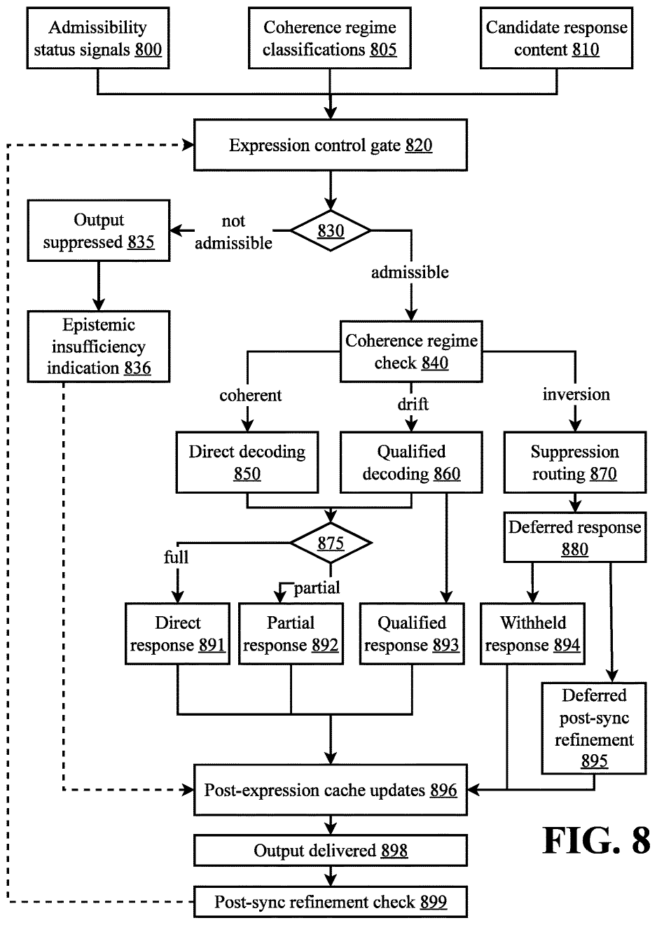

FIG. 8 is a flow diagram illustrating an exemplary output generation and expression control flow through which candidate response content received from an upstream governance pipeline is evaluated against admissibility status signals and coherence regime classifications, decoded through one of a plurality of expression pathways conditioned on the epistemic status of the reasoning from which the candidate response is derived, and delivered to a user or downstream process in one of five graduated output modes, with epistemic metadata refreshed following each expression event and deferred post-sync refinement queued where applicable for re-entry into the expression control flow upon restoration of network connectivity.

The flow receives inputs from three upstream blocks representing the epistemic governance state accumulated during prior admissibility evaluation, coherence monitoring, and suppression processing as described herein. An admissibility status signals block 800 carries admissibility determination outcomes for each candidate thought and reasoning trajectory participating in the candidate response, reflecting whether each participated as a directly admitted thought, a synthesized and re-evaluated thought, a corroborated drift-regime thought, or a thought whose admissibility status is pending or unresolved. A coherence regime classifications block 805 carries phase regime classification outcomes accumulated during coherence monitoring of the reasoning trajectories from which the candidate response is derived, reflecting whether the accumulated path-dependent coherence quantity remained within the coherent regime, entered the drift regime, or reached the inversion regime during traversal. A candidate response content block 810 carries the decoded candidate response produced by the response generation model from admitted thoughts. All three upstream inputs converge at an expression control gate 820.

The expression control gate 820 receives the admissibility status signals, coherence regime classifications, and candidate response content and conducts a joint evaluation of the epistemic governance state associated with the candidate response prior to initiating any decoding or output operation. The expression control gate 820 forwards the jointly evaluated inputs to an admissibility check 830, which determines whether the reasoning trajectory from which the candidate response is derived remains epistemically admissible through both admission evaluation and traversal monitoring as described with reference to prior figures herein. When the admissibility check 830 determines that no epistemically admissible reasoning trajectory supports the candidate response, processing is routed along the left branch to an output suppressed stage 835, at which decoding operations are structurally inhibited and the candidate response content is withheld from expression. The output suppressed stage 835 forwards processing to an epistemic insufficiency indication stage 836, which generates an indication to the user or downstream process that no epistemically admissible reasoning trajectory was available to support a response for the received prompt, and which may identify the nature of the epistemic deficiency where structural information is available to do so. The epistemic insufficiency indication 836 propagates a dashed path to the post-expression cache update stage 896 to ensure that the admissibility outcome associated with the suppression event is recorded in the epistemic metadata of the participating candidate thoughts. When the admissibility check 830 determines that an epistemically admissible reasoning trajectory supports the candidate response, processing is routed downward to a coherence regime check 840.

The coherence regime check 840 evaluates the coherence regime classification carried by the coherence regime classifications input 805 and branches processing into one of three decoding pathways based on the phase regime of the reasoning trajectory from which the candidate response is derived. Reasoning trajectories classified in the coherent regime are routed to a direct decoding stage 850, at which the candidate response content is decoded without qualification, reflecting that the reasoning maintained full epistemic coherence throughout traversal. Reasoning trajectories classified in the drift regime that have been corroborated by an independent reasoning path as described with reference to prior figures herein are routed to a qualified decoding stage 860, at which the candidate response content is decoded with an associated qualification reflecting that the reasoning required corroboration and is derived from adapted or synthesized rather than directly admissible cached content. Reasoning trajectories classified in the inversion regime or in the drift regime for which corroboration was not achieved are routed to a suppression routing stage 870, at which the candidate response content is withheld from direct expression and processing is forwarded to a deferred response stage 880.

The direct decoding stage 850 and qualified decoding stage 860 both forward their decoded outputs to a partial coverage check 875, which evaluates whether the admitted and coherent or corroborated reasoning trajectories support a full response to the received prompt or whether only a portion of the prompt requirements are addressed by the available epistemically admissible reasoning. When the partial coverage check 875 determines that full coverage is available, processing is routed along the left branch to a direct response output mode 891 for the coherent path or remains on the qualified path, reflecting that the full candidate response is supportable by admissible reasoning. When the partial coverage check 875 determines that only partial coverage is available, processing is routed downward to a partial response output mode 892, in which only the portions of the candidate response supported by admissible and coherent reasoning are expressed and unsupported portions are withheld, with an indication provided to the user identifying the scope of the partial response and the nature of the coverage limitation.

The deferred response stage 880 receives candidate responses from the suppression routing stage 870 and determines whether the absence of an admissible and coherent reasoning trajectory is attributable to a connectivity limitation that may be resolved upon restoration of network access or to a fundamental epistemic deficiency of the available cached thought set. When the deferred response stage 880 determines that connectivity restoration may enable retrieval of higher-admissibility candidate thoughts from remote cache tiers, processing is routed to a deferred post-sync refinement output mode 895, in which the candidate response is withheld pending synchronization and an indication is provided to the user that a refined response will be available upon connectivity restoration. When the deferred response stage 880 determines that the epistemic deficiency is not attributable to connectivity limitations, processing is routed to a withheld response output mode 894, in which the candidate response is withheld and an indication of epistemic insufficiency is provided to the user without a commitment to future refinement.

The five output modes (direct response 891, partial response 892, qualified response 893, withheld response 894, and deferred post-sync refinement 895) each forward their respective outputs or output indications to a post-expression cache update stage 896. The post-expression cache update 896 refreshes the epistemic metadata associated with all candidate thoughts that participated in the expression event, updating reuse success metrics, coherence regime classification history, contradiction history, and suppression proximity indicators based on the admissibility and coherence outcomes accumulated during the current processing cycle, regardless of which output mode was selected. The refreshed epistemic metadata is written back to the multi-tier thought cache to condition subsequent retrieval, admissibility evaluation, and synthesis decisions involving the same thoughts. The post-expression cache update 896 forwards the conditioned output to an output delivered stage 898, at which the selected output mode content is delivered to the user or downstream process.

The output delivered stage 898 forwards processing to a post-sync refinement check 899, which evaluates whether any deferred post-sync refinement obligations were incurred during the current expression event, reflecting that one or more candidate responses were withheld pending connectivity restoration as described above. When post-sync refinement is queued, the post-sync refinement check 899 propagates a dashed feedback path along the right margin of the figure to the expression control gate 820, such that upon restoration of network connectivity the deferred candidate response re-enters the expression control flow from the expression control gate 820 with updated admissibility status signals and coherence regime classifications reflecting higher-admissibility candidate thoughts retrieved from remote cache tiers following synchronization, enabling the system to produce a refined response to the original prompt without requiring resubmission by the user.

### Exemplary Computing Environment

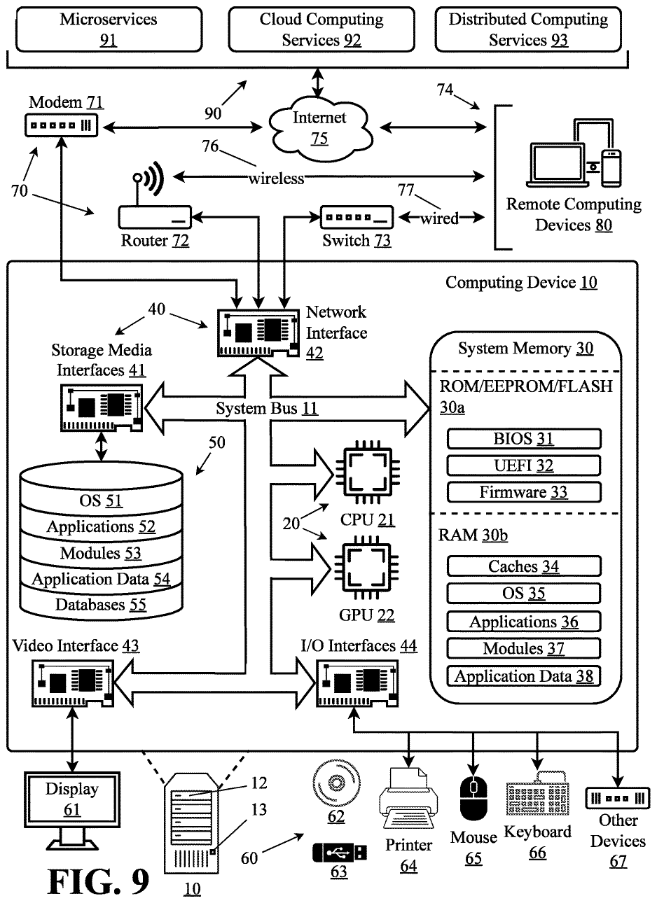

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
receive a prompt;
retrieve one or more candidate thoughts from a thought cache, wherein each candidate thought is a previously generated intermediate reasoning output associated with a prior prompt;
evaluate epistemic admissibility of each retrieved candidate thought prior to incorporating the candidate thought into response generation, wherein evaluating epistemic admissibility comprises determining, based on one or more structural properties of an epistemically conditioned cognitive substrate maintained by the system, at least one of:
structural compatibility of the candidate thought with a current prompt context, a capacity condition of a region of the cognitive substrate associated with the candidate thought, conflict between the candidate thought and constraint representations stored in one or more irreversible reservoirs, or an admissibility boundary condition applicable to the candidate thought;
admit candidate thoughts satisfying epistemic admissibility for participation in response generation and deny admission to candidate thoughts that do not satisfy epistemic admissibility;
generate a response to the prompt using one or more admitted candidate thoughts;
during generation of the response, monitor epistemic coherence of reasoning involving the admitted candidate thoughts by tracking a path-dependent coherence quantity and detecting a coherence failure condition;
in response to detecting a coherence failure condition, intervene in the reasoning by at least one of interrupting, redirecting, or marking as inadmissible the reasoning in which the coherence failure was detected;
in response to determining that a candidate thought or reasoning involving a candidate thought is epistemically inadmissible, generate a constraint representation and project the constraint representation into one or more irreversible reservoirs through a non-invertible operation, wherein the projected constraint representation influences subsequent thought retrieval and admissibility evaluations; and
generate an output conditioned on epistemic admissibility status of the reasoning from which the output is derived;
wherein when the computing device operates without network connectivity, the system adapts cached thoughts to address the prompt subject to epistemic admissibility evaluation, coherence monitoring, and output conditioning.

2. The computer system of claim 1, wherein the computer system is further configured to execute software instructions stored on the nontransitory machine-readable storage media that process the prompt using a first large language model optimized for execution on a resource-constrained computing device to generate a plurality of thoughts, and wherein generating the response comprises routing the prompt and one or more admitted candidate thoughts through a second large language model having fewer parameters than the first large language model.

3. The computer system of claim 1, wherein the thought cache comprises a local device cache stored on the computing device, a user-specific cloud cache storing a complete thought history for a user encrypted with user-specific keys, and a global generalized thought cache storing abstracted reasoning patterns applicable across a plurality of users, and wherein candidate thoughts are retrieved from one or more of the local device cache, the user-specific cloud cache, or the global generalized thought cache based on relevance to the prompt.

4. The computer system of claim 1, wherein evaluating epistemic admissibility of a candidate thought further comprises evaluating a structural compatibility residual measuring deviation between a geometric structure associated with the candidate thought and a geometric structure of a region of the epistemically conditioned cognitive substrate corresponding to the current prompt context, and denying admission when the structural compatibility residual exceeds a compatibility threshold, thereby preventing incorporation of candidate thoughts whose evidential grounding is geometrically incompatible with the current reasoning context.

5. The computer system of claim 1, wherein evaluating epistemic admissibility of a candidate thought further comprises querying the one or more irreversible reservoirs to determine whether the candidate thought matches a constraint representation stored therein, wherein a match indicates structural similarity to a previously identified inadmissible reasoning pattern, and denying admission to candidate thoughts for which a match is detected, such that constraint representations derived from prior inadmissible reasoning persistently exclude structurally similar candidate thoughts from future response generation without reconstructing the original inadmissible reasoning.

6. The computer system of claim 1, wherein monitoring epistemic coherence comprises classifying reasoning involving admitted candidate thoughts into phase regimes based on a magnitude of the path-dependent coherence quantity, comprising a coherent regime in which the path-dependent coherence quantity remains below a first threshold and consolidation of conclusions is permitted, a drift regime in which the path-dependent coherence quantity exceeds the first threshold but remains below a second threshold and consolidation is deferred pending corroboration by an independent reasoning path that reaches a substantially similar conclusion while remaining within the coherent regime, and an inversion regime in which the path-dependent coherence quantity meets or exceeds the second threshold and consolidation is blocked.

7. The computer system of claim 6, wherein the computer system is further configured to execute software instructions stored on the nontransitory machine-readable storage media that, when no directly admissible candidate thought is available for the prompt, synthesize a candidate thought by combining or transforming one or more cached thoughts, and wherein synthesized candidate thoughts are subject to epistemic admissibility evaluation and coherence monitoring under the same phase regime classification applied to retrieved candidate thoughts, and wherein a synthesized candidate thought that induces a drift or inversion regime classification is suppressed or generates a qualified output rather than a direct response.

8. The computer system of claim 1, wherein projecting the constraint representation into the one or more irreversible reservoirs through a non-invertible operation comprises discarding reconstructable details of the inadmissible candidate thought or reasoning trajectory while preserving a canonical constraint identifier usable to detect structurally similar inadmissible patterns in subsequent thought retrieval and admissibility evaluations, such that the original inadmissible thought or trajectory cannot be recovered from the projected constraint representation.

9. The computer system of claim 1, wherein the one or more irreversible reservoirs apply asymmetric constraint feedback to subsequent admissibility evaluations by providing read-only constraint pattern indices that influence admission decisions without being modifiable by active reasoning or response generation, such that the constraint feedback persistently narrows the set of admissible reasoning trajectories available for future thought reuse without permitting active reasoning to alter or erase stored constraint representations.

10. The computer system of claim 1, wherein generating an output conditioned on epistemic admissibility status comprises selecting among a plurality of output modes comprising a direct response mode in which a response is generated from one or more candidate thoughts that satisfied epistemic admissibility without transformation, a qualified response mode in which a response generated from transformed or synthesized candidate thoughts is accompanied by an indication that the response is derived from adapted reasoning rather than directly admissible cached content, a partial response mode in which only portions of a candidate response supported by admissible reasoning are expressed and unsupported portions are withheld, and a deferred response mode in which response generation is withheld pending restoration of network connectivity to enable retrieval of higher-admissibility candidate thoughts from remote cache tiers.

11. The computer system of claim 10, wherein when the computing device operates without network connectivity and no directly admissible candidate thought is available, the system selects an offline adaptation strategy comprising at least one of broadening a cached thought to extract underlying principles applicable to the current prompt, combining elements from a plurality of partially relevant cached thoughts to construct a composite candidate thought, applying a reasoning pattern from a cached thought in one domain to a structurally analogous situation in the domain of the current prompt, or modifying a cached thought through controlled parameter adjustments to align it with current prompt requirements, wherein each adapted candidate thought produced by the selected strategy is evaluated for epistemic admissibility prior to use in response generation and wherein the output mode is selected based on the admissibility status of the adapted candidate thought.

12. The computer system of claim 3, wherein each thought stored in the thought cache is assigned an epistemic status selected from a plurality of epistemic status tiers comprising at least a provisional status indicating that the thought has not yet been evaluated for admissibility, an admissible status indicating that the thought has satisfied epistemic admissibility evaluation and is eligible for reuse in response generation, a quarantined status indicating that the thought has exhibited coherence failure conditions during prior reuse and is excluded from response generation pending further evaluation, and a suppressed status indicating that the thought has been determined to be epistemically inadmissible and a corresponding constraint representation has been projected into the one or more irreversible reservoirs, wherein the epistemic status of each thought is maintained as metadata associated with the thought in the thought cache and is updated as the thought undergoes admissibility evaluation, reuse, and coherence monitoring.

13. The computer system of claim 12, wherein the computer system is further configured to execute software instructions stored on the nontransitory machine-readable storage media that promote a thought from a lower epistemic status tier to a higher epistemic status tier when the thought accumulates a history of successful admissibility evaluations and coherence-regime-consistent reuse across a plurality of prompts, and demote a thought to a lower epistemic status tier or to suppressed status when the thought exhibits coherence failure conditions, generates contradiction measures exceeding a threshold, or matches a constraint representation stored in the one or more irreversible reservoirs, such that epistemic status tiers are dynamically maintained based on accumulated reuse history rather than being fixed at thought generation time.

14. The computer system of claim 3, wherein the computer system is further configured to execute software instructions stored on the nontransitory machine-readable storage media that, prior to publishing a thought from the user-specific cloud cache to the global generalized thought cache, apply a dual-gate publication criterion requiring that the thought satisfies both a privacy criterion comprising removal of user-identifying information and context, and an epistemic criterion comprising at least one of a minimum epistemic status tier, an absence of matching constraint representations in the one or more irreversible reservoirs, a history of admissibility-consistent reuse across a plurality of contexts, and a contradiction measure below a publication threshold, such that thoughts are not promoted to the global generalized thought cache on the basis of privacy sanitization alone.

15. The computer system of claim 14, wherein the epistemic criterion further requires that the thought demonstrates stability under reuse, comprising maintaining coherent phase regime classification across a plurality of independent reasoning trajectories that employ the thought in different prompt contexts, and wherein a thought that satisfies the privacy criterion but fails the stability requirement is assigned quarantined status and is not published to the global generalized thought cache until stability is demonstrated, such that the global generalized thought cache contains only thoughts whose admissibility has been corroborated across diverse reuse contexts.

16. The computer system of claim 1, wherein the computer system is further configured to execute software instructions stored on the nontransitory machine-readable storage media that adjust an execution profile for response generation based on a combination of a resource state of the computing device comprising at least one of a battery level, available memory, or network connectivity state, and an epistemic risk level associated with available candidate thoughts comprising at least one of an epistemic status tier of the candidate thoughts, a magnitude of the path-dependent coherence quantity observed during prior reuse of the candidate thoughts, or a proximity of the candidate thoughts to constraint representations stored in the one or more irreversible reservoirs, wherein under conditions of low resource state or elevated epistemic risk, the system preferentially selects candidate thoughts of higher epistemic status, narrows the scope of response generation, or transitions to a qualified or deferred output mode.

17. The computer system of claim 16, wherein adjusting the execution profile comprises, when battery level of the computing device falls below a power threshold, dynamically reducing a complexity of thought generation and preferentially reusing cached thoughts of admissible epistemic status over generating new thoughts, and scheduling intensive thought generation, admissibility evaluation, and synchronization operations for periods in which the computing device is connected to a charging source, such that epistemic governance operations are distributed across available power states to maintain response quality while conserving battery resources.

18. The computer system of claim 3, wherein synchronization between the local device cache and the user-specific cloud cache comprises transferring not only thought content but also associated epistemic metadata comprising at least one of the epistemic status tier assigned to each thought, a history of admissibility evaluation outcomes for each thought, coherence regime classifications observed during prior reuse of each thought, and identifiers of constraint representations in the one or more irreversible reservoirs that are relevant to each thought, such that admissibility governance state accumulated on the computing device is preserved and made available across sessions and devices through the user-specific cloud cache.

19. The computer system of claim 18, wherein synchronization further comprises propagating constraint representations stored in the one or more irreversible reservoirs from the computing device to the user-specific cloud cache through a non-invertible transfer operation that preserves constraint pattern identifiers usable for future admissibility screening while discarding reconstructable details of the inadmissible reasoning from which the constraint representations were derived, such that suppression artifacts accumulated during offline operation become available to govern subsequent admissibility evaluations conducted when the computing device is connected to the network, without exposing underlying inadmissible reasoning content through the synchronization channel.

20. The computer system of claim 1, wherein each thought stored in the thought cache carries admissibility metadata comprising one or more of a structural compatibility marker indicating geometric compatibility of the thought with classes of prompt contexts for which the thought has been successfully admitted, a contradiction history recording coherence failure conditions detected during prior reuse of the thought, a reuse success metric reflecting a proportion of prior reuse instances in which the thought satisfied admissibility evaluation and maintained coherent phase regime classification, a transformation limit indicating a degree of synthesis or modification the thought may undergo while remaining eligible for admissibility evaluation rather than automatic suppression, and a suppression proximity indicator reflecting closeness of the thought to constraint representations stored in the one or more irreversible reservoirs, wherein the admissibility metadata is updated following each admissibility evaluation and reuse event and is used to prioritize thought retrieval and guide synthesis decisions prior to admissibility evaluation.
